(19) United States
(12) Patent Application Publication
(10) Pub. No.: US 2018/0082388 A1
(43) Pub. Date: Mar. 22, 2018

(54) SYSTEM, METHOD, AND PROGRAM

(71) Applicant: SONY CORPORATION, Tokyo (JP)

(72) Inventors: Shingo TAKAMATSU, Tokyo (JP); Takuya FUJITA, Kanagawa (JP)

(73) Assignee: SONY CORPORATION, Tokyo (JP)

(21) Appl. No.: 15/558,211

(22) PCT Filed: May 18, 2016
(86) PCT No.: PCT/JP2016/002436

§ 371 Date: Sep. 14, 2017

(30) Foreign Application Priority Data
Jun. 30, 2015 (JP) 2015-131364

(51) Int. Cl. G06Q 50/16; G06Q 30/02

(52) U.S. Cl. CPC G06Q 50/167; G06Q 30/0283; G06Q 30/0201; G06Q 30/0278

(57) ABSTRACT

A system that generates a first parameter corresponding to a type of an object; generates a second parameter corresponding to transaction information corresponding to the object; calculates a feature value corresponding to the object by applying a predetermined function to the first and second parameters; generates display data based on the calculated feature value; and outputs the display data to a device remotely connected to the system via a network.

### CROSS REFERENCE TO RELATED APPLICATIONS

This application claims the benefit of Japanese Priority Patent Application JP 2015-131364 filed Jun. 30, 2015, the entire contents of which are incorporated herein by reference.

### TECHNICAL FIELD

The present disclosure relates to an information processing apparatus, an information processing method, and a program.

### BACKGROUND ART

In recent years, in real estate dealings, information is searched for, and communication for buying and selling are exchanged through a network, such as the Internet, more often than ever. For example, in Patent Literature 1, there is described a technology that acquires user information and real estate information stored in a server, on the basis of a user identifier and a real estate identifier input into a client, and creates a referral for a preliminary inspection in which the acquired user information and the real estate information are written.

In such real estate dealings via the network, the adjustment of a sales price and a contract price of the real estate has been performed by guess of a real estate broker based on an assessed value.

### CITATION LIST

### Patent Literature

PTL 1: JP 2003-281252A

### SUMMARY

### Technical Problem

However, a method that relies on the guess of the real estate broker is low in reliability and objectivity, and does not present beneficial information inconveniently when a user (an owner, a seller) decides a sales price of real estate or adjusts a contract price. Such inconvenience has been the same in real estate rental via a network.

Thus, the present disclosure proposes an information processing apparatus, an information processing method, and a program which predict a contract probability of a real estate transaction, which is referred when deciding a sales/rental price of real estate and adjusting a contract price, in order to improve convenience of the real estate transaction.

### Solution to Problem

According to one exemplary embodiment, the disclosure is directed to a system that generates a first parameter corresponding to a type of an object; generates a second parameter corresponding to transaction information corresponding to the object; calculates a feature value corresponding to the object by applying a predetermined function to the first and second parameters; generates display data based on the calculated feature value; and outputs the display data to a device remotely connected to the system via a network.

According to another exemplary embodiment, the disclosure is directed to a system that generates a feature value corresponding to an object based on a type of the object and transaction information corresponding to the object; calculates a contract probability related to sale of the object over a predetermined transaction period based on the feature value corresponding to the object; and outputs display data indicating the contract probability during the predetermined transaction period.

According to another exemplary embodiment, the disclosure is directed to a method that includes generating a feature value corresponding to an object based on a type of the object and transaction information corresponding to the object; calculating a contract probability related to sale of the object over a predetermined transaction period based on the feature value; and outputting display data indicating the contract probability during the predetermined transaction period.

### Advantageous Effects of Invention

As described above, according to an embodiment of the present disclosure, the contract probability of the real estate transaction which is referred when deciding the sales/rental price of the real estate and adjusting the contract price is predicted in order to improve the convenience of the real estate transaction.

Note that the effects described above are not necessarily limited, and along with or instead of the effects, any effect that is desired to be introduced in the present specification or other effects that can be expected from the present specification may be exhibited.

### BRIEF DESCRIPTION OF DRAWINGS

FIG. 1 is a diagram illustrating a schematic configuration of a system according to an embodiment of the present disclosure.

FIG. 2 is a block diagram illustrating an inner configuration of a system according to an embodiment of the present disclosure.

FIG. 3 is a block diagram illustrating an exemplary function and configuration of a database and a processing unit of a server in an embodiment of the present disclosure.

FIG. 4 is a graph illustrating an example of a lognormal distribution according to the present embodiment.

FIG. 5 is a flowchart illustrating a feature value generation process according to the present embodiment.

FIG. 6 is a flowchart illustrating a process of vectorization when property information is a symbol, according to the present embodiment.

FIG. 7 is a flowchart illustrating a process of vectorization when property information is a continuous value, according to the present embodiment.

FIG. 8 is a flowchart illustrating a generation process of a feature value vector based on search query data according to the present embodiment.

FIG. 9 is a flowchart illustrating a generation process of a feature value vector based on page access data according to the present embodiment.

FIG. 10 is a flowchart illustrating a generation process of a feature value vector based on a movement log according to the present embodiment.

FIG. 11 is a flowchart illustrating a generation process of a feature value vector based on house movement data according to the present embodiment.

FIG. 12 is a diagram illustrating an example of a property information input screen image displayed in the present embodiment.

FIG. 13 is a diagram illustrating an example of a sales price consideration screen image displayed in the present embodiment.

FIG. 14 is a diagram illustrating an example in which a sales price consideration screen image displayed in the present embodiment is updated.

FIG. 15 is a diagram illustrating an exemplary screen image that displays an accumulation of a contract probability according to the present embodiment.

FIG. 16 is a diagram illustrating an exemplary screen image that displays a contract probability with a rank according to saleability, according to the present embodiment.

FIG. 17 is a diagram illustrating an exemplary screen image that displays a contract probability within a designated contract period according to the present embodiment.

FIG. 18 is a diagram illustrating an exemplary screen image that displays a list of predicted contract prices for each contract probability and each sales period according to the present embodiment.

FIG. 19 is a diagram illustrating an exemplary screen image that displays a contract probability with a score, according to the present embodiment.

FIG. 20 is a diagram illustrating an exemplary screen image that displays an automatic adjustment history of a sales price according to the present embodiment.

FIG. 21 is a diagram illustrating an exemplary screen image for setting a target contract period in an automatic adjustment of a sales price according to the present embodiment.

FIG. 22 is a diagram illustrating an exemplary screen image for setting a lower limit in automatic adjustment of a sales price according to the present embodiment.

FIG. 23 is a diagram illustrating an exemplary screen image that displays a contract probability of a brokered property according to the present embodiment.

FIG. 24 is a block diagram illustrating an exemplary hardware configuration of an information processing apparatus according to an embodiment of the present disclosure.

### DESCRIPTION OF EMBODIMENTS

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

Also, description will be made in the following order.

1. Overview of System According to Embodiment of Present Disclosure

1-1. Configuration of Client

1-2. Configuration of Server

2. Function and Configuration

2-1. Exemplary Configuration of Database

2-2. Exemplary Configuration of Processing Unit

3. Feature Value Generation Process

3-1. Generation of Feature Value Vector Based on Sales Data and Transaction History Data

3-2. Generation of Feature Value Vector Using Site Access Data

3-3. Generation of Feature Value Vector Using Movement Data

4. Exemplary Information Presentation Screen Image

5. Application Example

6. Hardware Configuration

7. Conclusion

### 1. Overview of System According to Embodiment of Present Disclosure

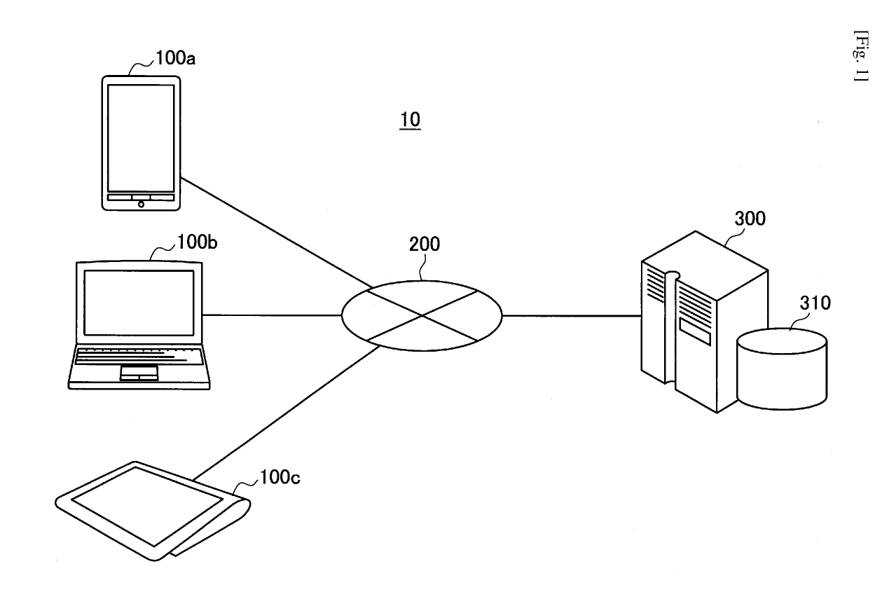

FIG. 1 is a diagram illustrating a schematic configuration of a system according to an embodiment of the present disclosure. Referring to FIG. 1, the system 10 according to the present embodiment includes a server 300 and clients 100. The clients 100 and the server 300 are connected by a network 200 to communicate with each other.

The clients 100 can include a smartphone 100a, a personal computer 100b, and a tablet 100c, for example. The clients 100 is not limited to the example illustrated in the drawing, but can include a terminal device of any type having a function for inputting information from and outputting information to a user. The clients 100 uses image or sound for example, to output information to the user. Also, the clients 100 may accept an input of information from the user, with an operation input of a terminal device, sound of a speech, or an image of a gesture or a sight line.

The server 300 includes one or a plurality of server devices on the network. When the plurality of server devices cooperate with each other to provide the function of the server 300 described below, the plurality of server devices may be handled as a whole as a single information processing apparatus. Alternatively, at least a part of the server device may be operated by an operator different from an operator of the server 300 described below. In this case, in the following description, a part of the server 300 can be referred to as an external server that is not included in the system 10. In the present embodiment, at least a part of the server device includes a database 310. In the database 310, information relevant to real estate and transaction history is stored.

The network 200 includes various types of wired or wireless networks, such as the Internet, a local area network (LAN) or a mobile telephone network, for example. The network 200 may connect a plurality of server devices included in the server 300, as well as connect the clients 100 and the server 300. When the network 200 includes a plurality of types of networks, the network 200 may include a router and a hub that connect those networks to each other.

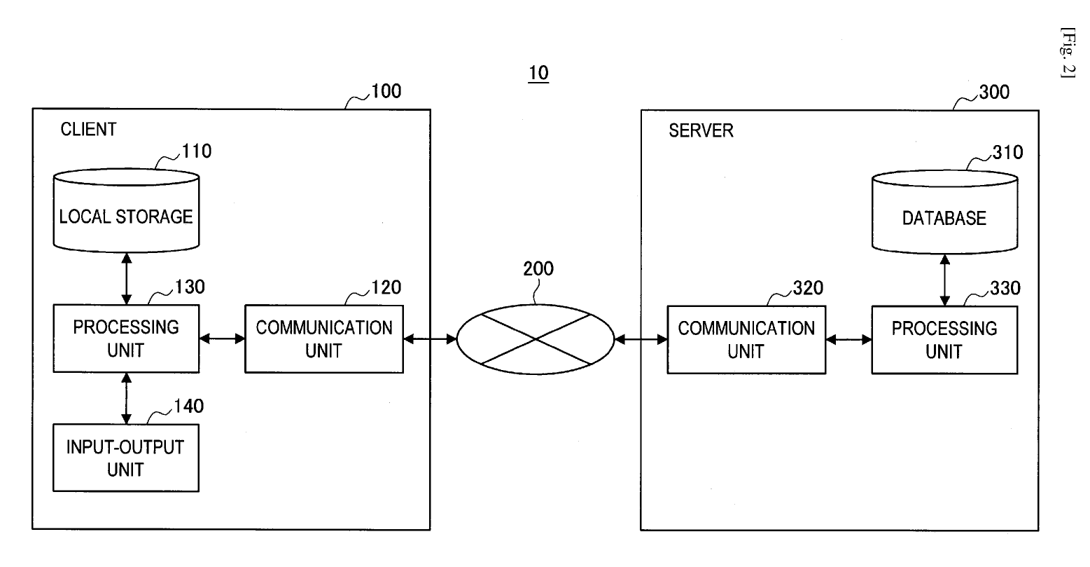

FIG. 2 is a block diagram illustrating an inner configuration of the system according to an embodiment of the present disclosure. Referring to FIG. 2, the clients 100 can include a local storage 110, a communication unit 120, a processing unit 130, and an input-output unit 140. The server 300 can include a database 310, a communication unit 320, and a processing unit 330. In the following, each function and configuration will be further described. Note that the terminal device that functions as the clients 100, and one or a plurality of server devices included in the server 300 are configured with the hardware configuration of the information processing apparatus described later, for example.

<1-1. Configuration of Client>

The local storage 110 is configured with a memory or a storage included in a terminal device, for example. For example, information provided from the server 300 via the network 200 and information input by the user via the input-output unit 140 are temporarily or persistently stored in the local storage 110. By utilizing the information stored in the local storage 110, the user can refer to the information provided from the server 300 offline, and input a draft of information that is provided to the server 300.

The communication unit 120 communicates with the server 300 via the network 200. The communication unit 120 is configured with a communication device that executes communication in the network to which the clients 100 are connected, for example.

The processing unit 130 is configured with a processor, such as a central processing unit (CPU), included in the terminal device, for example. For example, the processing unit 130 executes a process for requesting information to the server 300 via the communication unit 120, on the basis of the information input by the user via the input-output unit 140. Also, for example, the processing unit 130 executes a process for outputting information to the user via the input-output unit 140, on the basis of the information provided from the server 300 via the communication unit 120. In this case, the processing unit 130 may execute a process for converting the provided information to an appropriate form for the type of the input-output unit 140.

The input-output unit 140 is configured with an input device, such as a touch panel, a mouse, a keyboard, a microphone, or a camera (an image capturing device), and an output device, such as a display or a speaker, which are included in a terminal device, for example. Note that the input-output unit 140 may include only one of the input device and the output device. For example, the information received from the server 300 via the communication unit 120 is displayed on the display included in the input-output unit 140, after processed by the processing unit 130. Also, for example, an operation input of the user acquired by the touch panel included in the input-output unit 140 or the like is transmitted to the server 300 via the communication unit 120, after processed by the processing unit 130.

The functions of the above processing unit 130 and the input-output unit 140 are same as the functions of a processing unit and an input-output unit in a common terminal device for example, and thus are not described in detail in the following description of the present embodiment in some points. However, in that case as well, if the information received from the server 300 has a feature, the function of the processing unit 130 or the input-output unit 140 in the client 100 can be distinguishable in processing and outputting such information, as compared to the function in the common terminal device, for example.

<1-2. Configuration of Server>

The database 310 is configured with a memory or a storage included in the server device, for example. As described above, information relevant to real estates and their transaction is stored in the database 310. Also, information relevant to users of the clients 100 may be stored in the database 310. A more specific type of the information stored in the database 310 can differ depending on the content of the service provided by the server 300.

The communication unit 320 communicates with the clients 100 via the network 200. Also, the communication unit 320 may communicate with the external server via the network 200. The communication unit 320 is configured with a communication device that executes communication in the network to which the server 300 is connected, for example.

The processing unit 330 is configured with a processor, such as a CPU, included in a server device, for example. For example, the processing unit 330 acquires information from the database 310 on the basis of the information received from the clients 100 via the communication unit 320, and processes the acquired information as necessary, and then executes a process for transmitting it to the clients 100 via the communication unit 320.

Note that, when the server 300 includes a plurality of server devices, the function and configuration of the above server 300 can be distributed in a plurality of server devices. For example, the function of the database 310 may be configured intensively with one of the server devices, and may be configured by integratively operating the database distributed in a plurality of server devices. Also, for example, the function of the processing unit 330 may be configured by integratively operating the processor distributed in a plurality of server devices. In this case, the function of processing unit 330 described below can be distributed serially or parallelly in a plurality of server devices, regardless of types of functional blocks defined for the purpose of description.

### 2. Function and Configuration

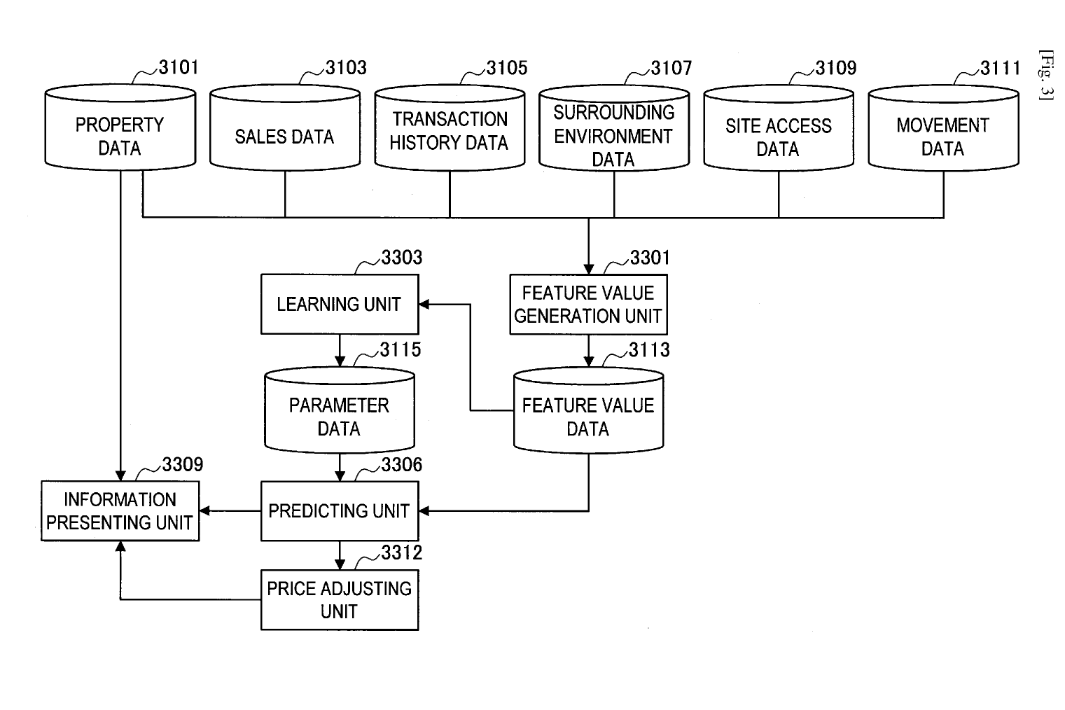

Next, the function and configuration of the database 310 and the processing unit 330 of the server 300 will be described with reference to FIG. 3.

FIG. 3 is a block diagram illustrating an exemplary function and configuration of the database and the processing unit of the server in an embodiment of the present disclosure. In the diagram, property data 3101, sales data 3103, transaction history data 3105, surrounding environment data 3107, site access data 3109, movement data 3111, feature value data 3113, and parameter data 3115 are illustrated as the function of the database 310 of the server 300. Also, in the diagram, a feature value generation unit 3301, a learning unit 3303, a predicting unit 3306, an information presenting unit 3309, and a price adjusting unit 3312 are illustrated as the function of the processing unit 330. In the following, each component will be further described.

<2-1. Exemplary Configuration of Database>

(Property Data 3101)

The property data 3101 functions as master data of the real estate property handled in the service provided by the server 300. The real estate property can include property of any type, such as land, independent building, apartment, town house, commercial property, for example. In the property data 3101, such data relevant to real estate property is registered in association with an ID unique to each property, for example. More specifically, data relevant to land can include property type, location, site area, and like, for example. Data relevant to building can further include floor area, room layout, facility, built period, direction of opening, daylighting state, and like. Further, data may include an image of an exterior appearance and inner portions of property or a scenery from property. For example, when a building is rebuilt or renovated, data associated with a new ID may be added as another property, and history such as rebuilding and renovation may be included in the property data 3101.

(Sales Data 3103)

The sales data 3103 includes the data relevant to ongoing sales of real estate properties registered in the property data 3101. More specifically, the sales data 3103 stores data such as property ID, sales date (year, month, and day), sales price (including change history), sales reason, current owner information (owner ID, demographics information, selling off reason (for example, whether change of residence or cashing)), agent who is responsible for sales, and introductory sentence created by owner or agent at time of sale. Also, data relevant to properties that are currently for sale is stored in the sales data 3103. The sales data 3103 is unique to sales body and property ID (for example, when a plurality of agents sell the same property in parallel, the sales data 3103 can be created for each agent, with respect to the same property ID). Also, when a transaction is settled with respect to a property for sale, a part or all of the sales data 3103 regarding the property is transferred to the transaction history data 3105.

(Transaction History Data 3105)

The transaction history data 3105 includes data relevant to settled transactions of real estate properties registered in the property data 3101. More specifically, the transaction history data 3105 stores data such as transaction ID, property ID, sales date, contract date, sales price (including change history), contract price, advertisement information (type of advertisement campaign, advertisement cost, posting medium and scale, post target, post period, and content of advertisement, etc.), sales reason, seller information (previous owner), buyer information (new owner; buyer, buyer ID, demographics information, purchase reason (for example, which one of change of residence and investment)), agents of seller side and buyer side, and introductory sentence created by owner or agent at time of sale. As described already, the transaction history data 3105 may be generated on the basis of the sales data 3103 of the property for which a transaction is settled. Alternatively, the transaction history data 3105 may be generated by importing the transaction history data provided by a service (including a public service) provided by the external server. The sales data 3103 is unique to sales body and property ID as described above, whereas in the transaction history data 3105 a plurality of data can exist for one property ID, if transactions are settled for the property a plurality of times in the past. Thus, as described above, a transaction ID may set separately in the transaction history data 3105, to uniquely identify each transaction.

(Surrounding Environment Data 3107)

The surrounding environment data 3107 includes data (for example, facility data, area data) relevant to the surrounding environments of the real estate properties registered in the property data 3101. The facility data includes the data relevant to various types of facilities that stand around the real estate properties. In this case, the facility data can include position information, type, name, open or close date of the facilities, and the like. The facility includes traffic facility such as station, store, evacuation facility, park, medical institution, school, for example. Also, the area data includes data relevant to the areas in which properties stand. In this case, the area data can include range, type, designation/cancellation date, and the like of the areas. The areas include administrative section, disaster caution zone, zoning on city planning, for example.

(Site Access Data 3109)

The site access data 3109 includes page access data, search query data in a real estate information site. The search query data is generated when the user execute search at the real estate information site, and includes search query ID, search query, search year, month, day, time point, and user ID, for example. Also, the page access data is generated when the user accesses a property sales page, and includes page access ID, property ID, access search year, month, day, time point, and user ID, for example.

(Movement Data 3111)

The movement data 3111 includes house movement data, movement logs of human beings. The movement logs of human beings are the data based on the global positioning system (GPS) information or the like of a person, which is acquired real time from a mobile device such as a smartphone. For example, the movement logs include latitude, longitude, year, month, day, time point, and user ID. The house movement data includes address (in the present specification, “address” is used in the meaning of “location”), carrying-in/carrying-out information, and year, month, and day, for example, and is added each time house movement is performed. When the house movement data is symbolized as the feature value of the property by the feature value generation unit 3301 described below, “1” is input as the house movement data when carrying-in is performed at the time of the house movement, and “0” is input as the house movement data when carrying-out is performed, for example.

(Feature Value Data 3113)

The feature value data 3113 includes feature values (hereinafter, also referred to as property feature value) of the real estate properties registered in the property data 3101. The property feature value is generated by the feature value generation unit 3301 by using at least one or more of the property data 3101, the sales data 3103, the transaction history data 3105, the surrounding environment data 3107, the site access data 3109, and the movement data 3111, for example. Specifically, for example, the property feature value can be a vector extracted from each data item, with respect to a certain property (identified by the property ID). In the feature value data 3113, this property feature value vector can be stored in association with property ID. Basically, one property feature value is stored for one property. Thus, the feature value data 3113 can be utilized as the information that indicates the current state of the property, for example. Note that the detail of the process of the feature value generation unit 3301 for generating the property feature value will be described later.

(Parameter Data 3115)

The parameter data 3115 is learned by the learning unit 3303 (decided by maximum likelihood estimation, for example), and includes various types of parameters used in the predicting unit 3306. Various types of parameters are used in various types of prediction processes by the predicting unit 3306.

That is, the parameter data 3115 includes various types of parameters used in a prediction process of contract probability. The above prediction process is performed by the predicting unit 3306, for the purpose of calculating the contract probability in a predetermined sales period (a predetermined period from a sales start day) of the real estate property of prediction target by use of a prediction model.

Also, the parameter data 3115 includes a weight parameter set for each item of the property feature value when determining whether or not the property is similar. For example, the learning unit 3303 learns a relationship between the property feature value and the contract price, and decides the parameter in such a manner to set a higher value to the property whose degree of similarity calculated by using the parameter that exhibits the same transaction price tendency.

Also, the parameter data 3115 includes various types of parameters used in the prediction process of the contract price by the predicting unit 3306.

In the above, an exemplary configuration of the database 310 has been described. Lastly, the feature values that can be included in the above feature value data 3113 will be illustrated again. Property feature value (room layout, built year, area size, structure, number of stories, right of site), surrounding facility feature value (nearest station, nearest supermarket, nearest bus stop, nearest highway entrance, dam, evacuation facility, sightseeing facility, park, public facility, medical institution, school), surrounding area feature (crime map, height above sea level, cliff, liquefaction, sea coast, river, forest, farm land, administrative area, city planning, heavy snowfall area, soil, disaster map, average air temperature, weather, major road side, railway track side, airport base, island, peninsula), property photograph (exterior appearance photograph, view from veranda, room layout diagram, and room. non-data information such as grade and scenery of apartment is obtained to improve prediction accuracy), property explanatory text (text of property sales pitch, word-of-mouth of social media. non-data information such as duplex or not, and sunshine, and reputation is obtained to improve prediction accuracy), sensor data (ambient noise, sunshine, airiness, fallen leaves, radio wave situation), neighborhood resident, human being movement log (popularity of area, taxi, moving amount of people. GPS information of people acquired real time from mobile device such as smartphone is utilized to observe real popularity of area, and thereby prediction accuracy is improved), economic index (average stock price, employment statistics, increase and decrease of population of area), road around land (in case of solitary house), renovation information, number of similar properties for sale, current sales tendency, transaction period (state of current market is considered in prediction to improve prediction accuracy), negotiating broker company, owner, roadside land price, official land price, leasehold, fixed property tax, selling off reason, purchase reason (change of residence due to change of family members, change of residence due to company transfer, change of residence due to marriage or divorcement, or change of residence due to dissatisfaction to property, purchase for investment. contract price is affected by reason, and thus prediction accuracy is improved), buying and selling date, circumstances for selling early (change of residence due to change of family members, change of residence due to company transfer, change of residence due to marriage or divorcement, change of residence due to dissatisfaction to property, purchase for investment, or selling off inherited property. for example, there is a case in which one wants to sell early even at a low price, and buying and selling date is utilized to improve prediction accuracy), service charge, rent, parking charge, empty rate (if empty rate of apartment or like is high, price tends to decrease), real estate transaction amount of area (as real estate transaction amount of area increase, price tends to become higher), money amount used for advertisement when selling off, accident property or not.

<2-2. Exemplary Configuration of Processing Unit>

(Feature Value Generation Unit 3301)

The feature value generation unit 3301 generates a feature value of a real estate property, on the basis of at least one or more of the property data 3101, the sales data 3103, the transaction history data 3105, the surrounding environment data 3107, the site access data 3109, and the movement data 3111. The generated feature value can be stored as the feature value data 3113. Note that the feature value generation unit 3301 generates the feature value periodically (for example, at a frequency of once a day), and can update the feature value data 3113 of each property.

In the present embodiment, the feature value can be a vector (feature value vector) extracted from data, for example. This feature value vector may be generated by simply coupling items of the data, for example. The present embodiment may generate a feature value vector for each property ID for uniquely identifying a property, and may store, as the feature value data 3113, a combination of six data such as “property ID, feature value vector, contract price per square meter, sales price per square meter, sales year, month, and day, contract year, month, and day”. Also, the combination of these six data is referred to as property feature value entry. The contract price per square meter, the sales price per square meter, the sales year, month, and day, and the contract year, month, and day are acquired from the transaction history data 3105. Each is set to null, when the contract price per square meter, the sales price per square meter, the sales year, month, and day, and the contract year, month, and day does not exist. Detail of generation of the feature value vector will be described later.

(Learning Unit 3303)

The learning unit 3303 performs machine learning by using the feature value data 3113, and functions as a generation unit that calculates (generates) various types of parameters. For example, the learning unit 3303 calculates, by machine learning, various types of parameters that are used in a contract probability prediction model used in a contract probability prediction process by the predicting unit 3306. In the following, learning of the contract probability prediction model by the learning unit 3303 will be described specifically. Note that the learning method described below is an example, and is not necessarily limited thereto.

First, the learning unit 3303 modelizes the decision method of contract period y as illustrated in the below formula 1. In the below formula 1, the contract period y indicates the number of days from the sales start day of the property to the contract, and x indicates a feature value vector of the property, and f(x) indicates a function that returns a real number value, and epsilon indicates noise.

[Math.1]

y=f(x)+ε formula 1

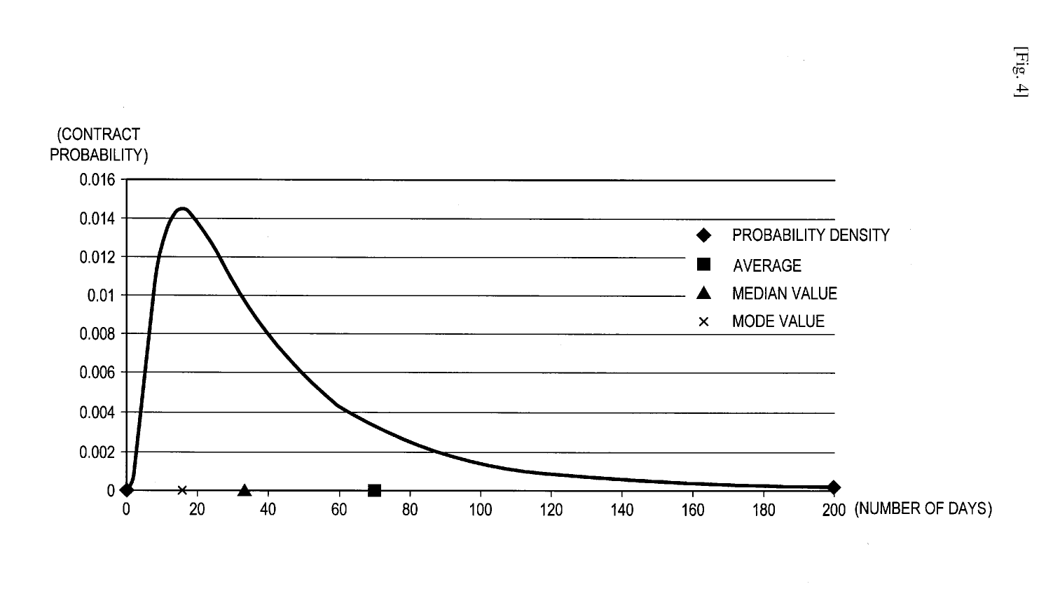

The noise used in the above formula 1 is distributed according to lognormal distribution, for example. In the present embodiment, prediction accuracy is increased by distributing according to the lognormal distribution which is close to real contract probability distribution, instead of normal distribution. Here, an example of the lognormal distribution is illustrated in FIG. 4. In the graph illustrated in the drawing the horizontal axis is the number of days, and the vertical axis is contract probability. When the lognormal distribution is employed, the estimation algorithm for performing maximum likelihood estimation is relatively simple as compared with gamma distribution or the like.

F(x) uses a linear regression function which is expressed as f(x)=w^{t}x+w₀. Note that f(x) may be any function other than the linear regression function, and can use polynomial regression and multi layer neural net, for example. W is a parameter vector, and w₀ is a parameter of a real number value. When expressed with probability distribution, the contract probability p of the target property (the target property having the feature value vector x) within the contract period y is calculated by the below formula 2. In the below formula 2, sigma is a parameter of lognormal distribution of noise.

$$\begin{matrix}[ Math . 2 ] & formula 2 \\ p ( y \vert x ) = \frac{1}{\sqrt{2 π} σ y} exp ( - \frac{( log y - f ( x ) )}{2 {σ}^{2}} ) & \end{matrix}$$

In the present embodiment, the above various types of parameters w (parameter vector), w₀ (parameter of a real number value), sigma (parameter of lognormal distribution of noise) can be estimated by using the maximum likelihood estimation for example, by the learning unit 3303. For example, the learning unit 3303 prepares learning data by selecting, as x, a feature value vector having both of a non-null contract price per square meter and non-null contract year, month, and day, from among the combinations of six data stored in the feature value data 3113 (property feature value entry; property ID, feature value vector, contract price per square meter, sales price per square meter, sales year, month, and day, and contract year, month, and day), and setting y to the number of days from the sales start day to the contract day. Then, the learning unit 3303 searches for (estimates) the parameter that maximizes the likelihood, which is led from the prepared learning data. Note that, each feature value vector is modified as described next, before the maximum likelihood estimation is performed. That is, the feature value generation unit 3301 generates the feature value of each property (including all properties that are for sale and has been contracted already) periodically, and therefore the feature value vector generated on the basis of the information of the immediately previous specific period from the current time point is stored in the feature value data 3113. Thus, when the maximum likelihood estimation is performed, the accuracy of the prediction is improved, by modifying to the feature value vector generated on the basis of the information of immediately previous specific period from the sales start day of a property that has reached a contract with respect to the property that has reached the contract (a property having both of a non-null contract price per square meter and non-null contract year, month, and day).

The learning unit 3303 decides (calculates) various types of parameters (w, w₀, sigma) by the maximum likelihood estimation, on the basis of the above each modified feature value vector. The calculated various types of parameters are stored as the parameter data 3115. Then, various types of parameters are assigned to the above formula 2 together with the feature value vector x of the prediction target property and the designated number of elapsed days y (the number of elapsed days from the sales start day), in the predicting unit 3306 described later, and are used in the prediction process of the contract probability p.

Although, in the example described above, various types of parameters are estimated on the basis of the feature value vector of the property that has reached the contract, the present embodiment is not limited thereto but can estimate various types of parameters by utilizing the feature value vector of a property that has not reached a contract as well, for example.

For example, with regard to the same buyer i, the feature value vector of the property that has reached a contract is x_{i,s}, and the feature value vector of the property that has not reached the contract is x_{i,f}, and a function with the below formula 3 added in the likelihood is minimized in order to decide various types of parameters (w, w₀, sigma). The gamma of the below formula 3 is an adequate real number value. The below formula 3 has an effect to give a penalty, when the contract period of the highest probability for the contract that has not been reached becomes shorter than the contract period of the highest probability for the contract that has been reached.

[Math.3]

γΣᵢ(max_{y}_{ᵢ}p(yᵢ|x_{i,s},w)−max_{y}_{ᵢ}p(yᵢ|x_{i,f},w)) formula 3

(Predicting Unit 3306)

The predicting unit 3306 predicts the contract probability within a predetermined sales period of the target property, on the basis of the parameter (the parameter data 3115) calculated by the learning unit 3303 and the feature value vector (the feature value data 3113) generated by the feature value generation unit 3301 with respect to the target property. That is, the predicting unit 3306 predicts the contract probability of a predetermined transaction period, on the basis of the settlement period and the feature value data of the target real estate property in the past settled transaction and the feature value of the target real estate property of the transaction of the current prediction target. For example, the predicting unit 3306 predicts the contract probability within a predetermined transaction period, by using the parameter for calculating the contract probability corresponding to the contract period according to the feature value, which is generated from the settlement period and the feature value in the target real estate property of the past settled transaction having (similar) the feature value that is same as the feature value of the real estate property of the current prediction target. The present embodiment learns by using, as the feature value, the data other than the data relevant to the property and the property transaction such as the property data 3101, the sales data 3103, the transaction history data 3105, and the surrounding environment data 3107, for example the site access data 3109 and the movement data 3111, and executes a prediction process of contract probability, in order to perform the prediction of the contract probability more accurately.

The prediction process of the contract probability can be performed before the sale of the target property, that is, at the stage where a seller considers selling, for example. In this case, the predicting unit 3306 predicts the contract probability within a predetermined sales period of the target property, on the basis of the feature value vector of the property similar to the target property, for example. A predetermined sales period may be a transaction period designated by the user in the clients 100, and may be a transaction period set automatically at the server 300 side. Also, the predicting unit 3306 may predict each of contract probabilities of a plurality of transaction periods (for example, contract probability of one month, contract probability of two month from sales, etc.).

Also, the prediction process of the contract probability may be performed after the sale of the target property at the stage where the transaction has not been settled yet. In this case, the predicting unit 3306 predicts the contract probability of settling the transaction during a predetermined transaction period, such as within one month and within two months, on the basis of the same information as above, and the information relevant to the sale of the target property (the number of elapsed days from the sales start day, the sales price, etc.).

Further, the prediction of the contract probability may be performed after the settlement of the transaction of the target property. In this case, the prediction result of the contract probability is fed back to the learning unit 3303, and is utilized in the learning based on the difference from the actual contract period by the learning unit 3303, for example.

Also, the predicting unit 3306 can perform prediction of the price (also referred to as contract price) at which the transaction is settled, in the same way as the contract probability. Specifically, first, the learning unit 3303 learns in advance the relationship between the feature value and the contract price among the properties of high degrees of similarity, and decides the parameter for reflecting the difference of the feature values appropriately to the prediction price, and stores it in the parameter data 3115. When deciding such a parameter, the learning unit 3303 utilizes publicly known various types of algorithms, such as a gradient method, for example. Then, the predicting unit 3306 predicts the contract price on the basis of the feature value of the sales property and the above parameter decided by the learning unit 3303.

Further, the predicting unit 3306 can predict the period (also referred to as contract period) within which the transaction is settled, in the same way as the contract probability. When using the prediction model (and various types of parameters) of the contract probability learned by the learning unit 3303 in the prediction of the contract period, the predicting unit 3306 calculates not only an average value but also a mode value or a median value, in order to use it as the predicted value of the contract period. Also, the predicting unit 3306 can increase the number of cases whose errors are equal to or less than a specific value, by using the mode value instead of the average error. As the confidence width of the contract period, 90% confidence interval or the like can be calculated by converting the lognormal distribution to the normal distribution.

(Information Presenting Unit 3309)

The information presenting unit 3309 presents the information including the prediction of the contract probability, the prediction of the contract price, or the prediction of the contract period of the real estate property predicted by the predicting unit 330, to the user via the clients 1006. More specifically, the information presenting unit 3309 generates data for outputting an image on the display included in the input-output unit 140 at the clients 100, and transmits it to the clients 100 from the communication unit 320. Note that the method of the information output in the clients 100 is not limited to image display, but sound output may be employed together with or instead of the image display, for example.

(Price Adjusting Unit 3312)

The price adjusting unit 3312 includes a function for automatically adjusting the sales price of the target property, on the basis of the prediction result of the contract probability of the target property calculated by the predicting unit 3306. In the present embodiment, the sales price set by the seller continues to be presented to the buyer side during the sales period in real estate buying and selling via the network, the contract probability changes due to the change of the feature value relevant to demand and supply, and thus the price setting appropriate for the demand and supply is achieved by adjusting the sales price in response to the contract probability over time. For example, at the time of sales start, the seller decides the sales price on the exemplary information presentation screen image described later. Thereafter, each time the prediction contract probability is updated, the price adjusting unit 3312 adjusts the sales price. Specifically, the price adjusting unit 3312 adjusts the sales price in such a manner to raise the sales price when the contract probability increases during a certain period from the present moment, and on the other hand reduce the sales price when the contract probability decreases. Also, the price adjusting unit 3312 can adjust the sales price in such a manner that the contract probability during a certain period from the present moment is constant. This period and the contract probability may be set by the seller, and may be set in advance at the system side.

In the above, the function and configuration of the database 310 and the processing unit 330 of the server 300 according to the present embodiment has been described. Although buying and selling transaction of the real estate is used as one example in the present embodiment, the real estate transaction according to the present embodiment is not limited thereto but can also be employed in rental transaction of real estate. In that case, rental data is stored in the database 310 instead of the sales data 3103 for example, and the transaction history data 3105 includes information relevant to rental transaction, and the contract probability is predicted on the basis of these.

### 3. Feature Value Generation Process

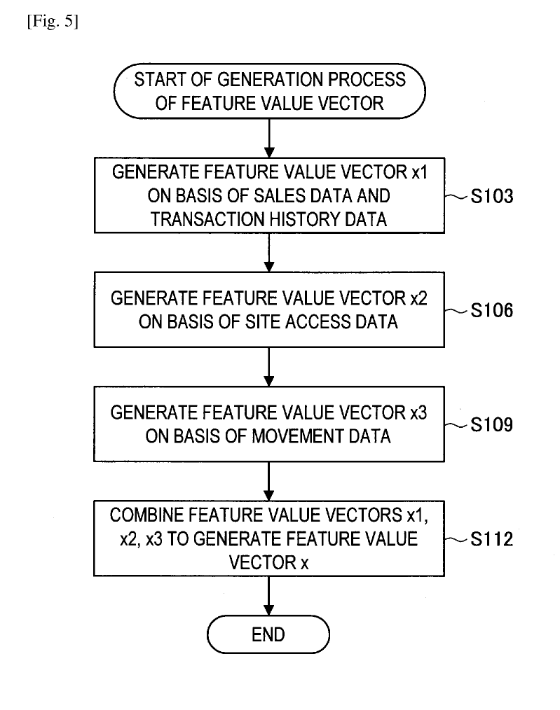

Subsequently, the feature value generation process according to the present embodiment will be described specifically with reference to FIGS. 5 to 11.

FIG. 5 is a flowchart illustrating the feature value generation process according to the present embodiment. As illustrated in FIG. 5, first, in S103, the feature value generation unit 3301 generates the feature value vector x1 of the target property, on the basis of the sales data 3103 and/or the transaction history data 3105. Specifically, the feature value vector x1 is generated by using the sales data 3103 when the target property is for sale, and the transaction history data 3105 when the target property has reached a contract.

Thereafter, in S106, the feature value generation unit 3301 generates the feature value vector x2 on the basis of the site access data 3109. Specifically, access data to the web site of the target property and/or search query data is used to generate the feature value vector x2.

Thereafter, in S109, the feature value generation unit 3301 generates the feature value vector x3 on the basis of the movement data 3111. Specifically, the statistics amount of the movement data of an immediately previous predetermined period around the target property is used to generate the feature value vector x3.

Then, in S112, the feature value generation unit 3301 combines the feature value vectors x1, x2, x3 of the generated target property, in order to generate the feature value vector x.

Although the above explanation describes one example in which the feature value vector x is generated by using the sales data 3103, the transaction history data 3105, the site access data 3109, and the movement data 3111, the present embodiment is not limited thereto but may generate the feature value vector x from the feature value vectors of at least one or more data of these data, for example.

<3-1. Generation of Feature Value Vector Based on Sales Data and Transaction History Data>

The feature value generation unit 3301 can generate the feature value vector of the property, by using the sales data 3103 and the transaction history data 3105. In the sales data 3103, information (hereinafter, referred to as property information entry) relevant to the properties that are currently for sale is stored. For example, the sales data 3103 includes property ID, and property feature information (address (location), position information (latitude and longitude), occupied area, built year, room layout type, balcony direction, building name, room number, surrounding environment (for example, population of surrounding area, component of population, change of population, etc.)). Also, in the transaction history data 3105, information (hereinafter, referred to as property information entry) relevant to the properties that have reached the contract is stored. For example, the transaction history data 3105 includes property ID, sales information (sales price, sales year, month, and day), contract information (contract price, contract year, month, and day), advertisement information (type of advertisement campaign, advertisement cost, posting medium and scale, post target, post period, and content of advertisement, etc.), property owner (seller) information (owner ID, demographics information, selling off reason (which one of change of residence or cashing)), buyer information (buyer ID, demographics information, purchase reason (which one of residency or investment)).

The feature value generation unit 3301 generates the vector (the feature value vector) extracted from the data as the property feature value, for each property information entry. This feature value vector may be generated by simply combining the items of the data, for example.

(In Case of Symbol)

For example, when the property information entry is symbol, a vector having dimensions according to the number of symbol types is created, and a symbol feature value with the dimensions of corresponding symbols set to 1 and other dimensions set to 0 is generated.

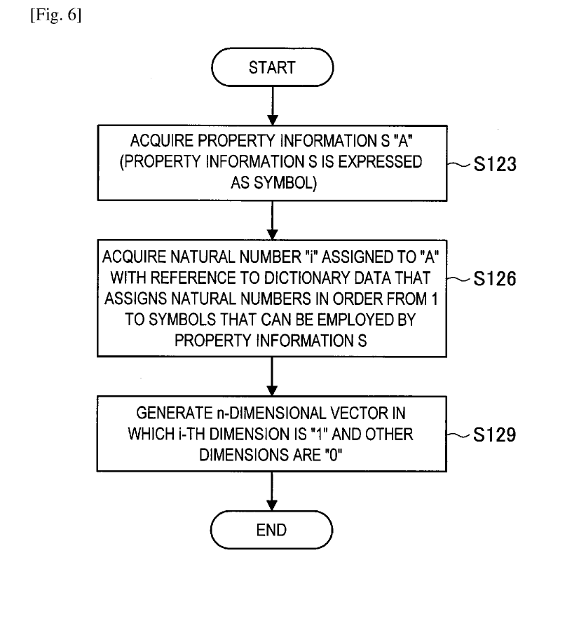

More specifically, for example, the item of the direction can be handled as a numerical value, by setting classification values as in “east=1, south=2, west=3, north=4”. Location can also be handled as a numerical value, by setting classification values to municipalities and the town names, or by expressing with latitude and longitude, for example. Note that, in this numerical conversion, binarization of a vector that is a component of the feature value vector may be performed. In this case, for example, in the above example of direction, a component of the feature value vector indicating direction is a 4-dimensional vector, and in the case of east (1, 0, 0, 0), and in the case of south (0, 1, 0, 0), and in the case of west (0, 0, 1, 0), and in the case of north (0, 0, 0, 1). The vectorization process when the property information entry is symbol is illustrated in FIG. 6.

FIG. 6 is a flowchart illustrating the vectorization process when the property information is symbol, according to the present embodiment. As illustrated in FIG. 6, first, in S123, the feature value generation unit 3301 acquires the property information S “A” of the target property. Here, the property information S is expressed as a symbol.

Thereafter, in S126, the feature value generation unit 3301 acquires a natural number “i” assigned to “A” with reference to the dictionary data that assigns natural numbers in the order from 1 to the symbols that can be employed by the property information S.

Thereafter, in S129, the feature value generation unit 3301 generates an n-dimensional vector (n is the number of symbols that can be employed by the property information S) in which the i-th dimension is “1” and other dimensions are “0”.

(In Case of Continuous Value)

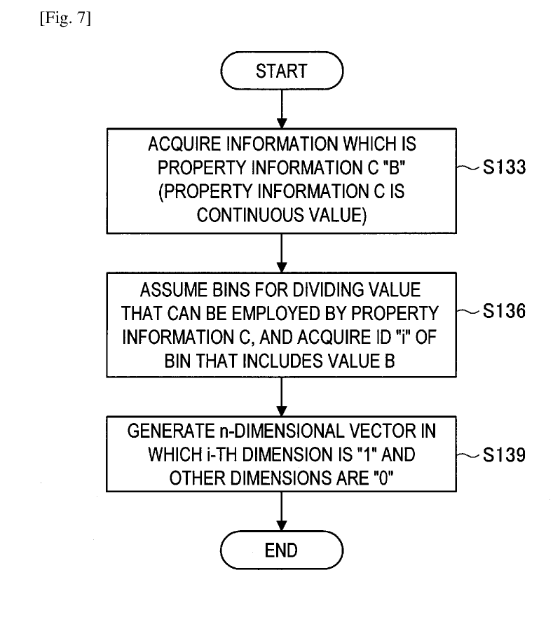

Also, the items for which the property information entry is recorded as a continuous numerical value, such as site area and floor area, may be handled as the numerical value as it is to generate the feature value, and may be handled as data binarized by dividing the range of the numerical value into bins of appropriate widths. The items recorded as a date, such as built period, sales data, and contract data, may be handled in the same way as the continuous numerical value, and may be handled as different data by extracting year and month from the date. When the data is binarized by dividing the range of numerical value into the bins of appropriate widths, for example, when the bins of 10 m² width are set for the site area in the example of the above site area, a vector is obtained in which the fourth component of the vector is 1 when the site area is 40 m², and the fifty seventh component is 1 when the site area is 570 m², and the remaining components are 0. The maximum value (for example, the same bin is used for 1000 m² or more) and the minimum value may be set to prevent the dimension of vector from becoming large without limitation. The vectorization process when the property information entry is a continuous value is illustrated in FIG. 7.

FIG. 7 is a flowchart illustrating the vectorization process when the property information is a continuous value, according to the present embodiment. As illustrated in FIG. 7, first, in S133, the feature value generation unit 3301 acquires the property information C “B” of the target property. Here, the property information C is a continuous value.

Thereafter, in S136, the feature value generation unit 3301 assumes the bins for dividing the value that can be employed by the property information C, and acquires the ID “i” of the bin that includes the value B.

Thereafter, in S139, the feature value generation unit 3301 generates an n-dimensional vector in which the i-th dimension is “1” and other dimensions are “0”. Note that n is the number of bins for dividing the value that can be employed by the property information C, and natural numbers are assigned in the order from smaller one as the IDs of the bins.

(In Case Using Plurality of Data)

When both of the sales data and the transaction history data of the target property exist, the feature value generation unit 3301 may create independent feature value vectors for “(sales price−contract price)/(proprietary area)”, year, and month of sales year and month, respectively. Also, when only the sales data exists, the feature value generation unit 3301 may calculate a predicted contract price instead of the contract price, and set “(sales price−predicted contract price)/(proprietary area)” as the feature value vector.

(Vectorization of Advertisement Information)

The feature value generation unit 3301 may handle a combination of feature value and advertisement cost for the type of advertisement campaign, as one symbol feature value, in the advertisement information. Here, the feature value generation unit 3301 utilizes the advertisement cost which is converted by rounding to ten-thousand yen order in advance.

(Utilization of Similar Property)

The feature value generation unit 3301 may generate the feature value vector of the target property, on the basis of the contract situation of the property similar to the target property. For example, the feature value generation unit 3301 sets, as the feature value, the sum of contracts of similar properties within the immediately previous certain specific period, in order to generate the feature value vector. Here, the degree of similarity between properties may be calculated as a monotonically decreasing function of Mahalanobis distance of the feature value vector based on the property information entry of each property, for example. Also, the similar property refers to a property whose degree of similarity is equal to or greater than a specific value.

<3-2. Generation of Feature Value Vector Using Site Access Data>

Next, generation of the feature value vector using the site access data 3109 will be described. As described above, search query data and page access data are stored in the site access data 3109, and the feature value generation unit 3301 can generate the feature value vector of the target property by using the search query data or the page access data. In the following, it will be described specifically.

(Generation of Feature Value Vector Based on Search Query Data)

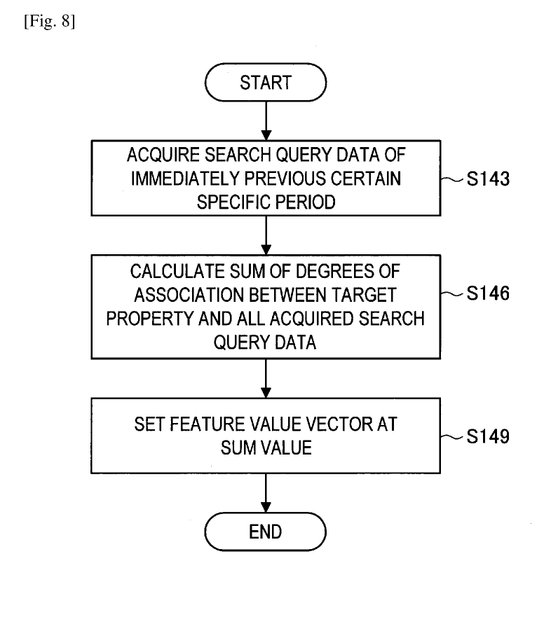

FIG. 8 is a flowchart illustrating the generation process of the feature value vector based on the search query data according to the present embodiment. As illustrated in FIG. 8, first, in S143, the feature value generation unit 3301 acquires the search query data of the immediately previous certain specific period, from the site access data 3109.

Thereafter, the feature value generation unit 3301 calculates the sum of the degrees of association between the property information entry of the target property and the acquired all search query data of immediately previous specific period. The calculation method of the degree of association between the property information entry and the search query data can employ one of below two methods, for example. The first method assumes the property feature information included in the property information entry of the target property as a character string, and sets 1 to the degree of association when the search query data is included in the character string, and sets 0 to the degree of association when the search query data is not included. The second method utilizes the page access data. 1 is set for the degree of association of the property information entry corresponding to the page that is accessed within a certain amount of time after the search query is generated, and 0 is set for the degree of association of the property information entry that does not correspond to any access page.

Thereafter, in S149, the feature value generation unit 3301 sets the value of the sum of the degrees of association with the search query data of the calculated target property, as the feature value vector of the target property.

(Generation of Feature Value Vector Based on Page Access Data)

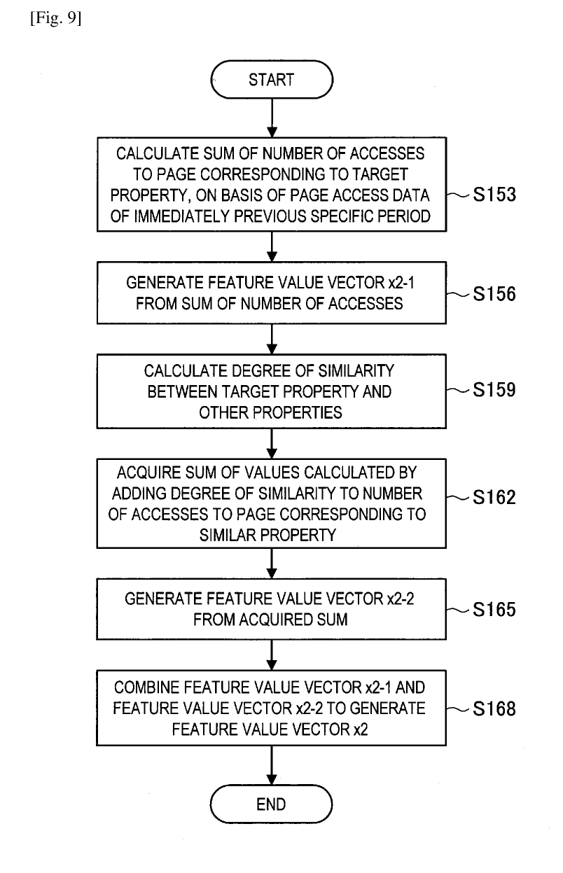

FIG. 9 is a flowchart illustrating the generation process of the feature value vector based on the page access data according to the present embodiment.

As illustrated in FIG. 9, first, in S153, the feature value generation unit 3301 calculates the sum of the number of accesses to the page corresponding to the target property (for example, the web page on which the information of the target property is posted), on the basis of all page access data of the immediately previous specific period.

Thereafter, in S156, the feature value generation unit 3301 generates the feature value vector x2-1 from the sum of the number of accesses.

Thereafter, in S159, the feature value generation unit 3301 calculates the degree of similarity between the target property and other properties. Specifically, the degree of similarity can be calculated on the basis of the distance between the feature value vectors of the target property and another property. Also, the degree of similarity may be a larger value as the distance between the feature value vectors is smaller.

Thereafter, in S162, the feature value generation unit 3301 acquires the sum calculated by adding the degree of similarity to the number of accesses to the page corresponding to a similar property, with respect to another property (the similar property) whose degree of similarity is equal to or greater than a specific value.

Thereafter, in S165, the feature value generation unit 3301 generates the feature value vector x2-2 from the acquired sum.

Then, in S168, the feature value generation unit 3301 combines the above calculated feature value vector x2-1 and the feature value vector x2-2, in order to generate the feature value vector x2.

In the above, the generation process of the feature value vector x2 based on the page access data has been described. Although here the sum of the number of page accesses is used as one example, the present embodiment is not limited thereto but may use the number of unique user IDs that have accessed the page.

<3-3. Generation of Feature Value Vector Using Movement Data>

Next, generation of the feature value vector using the movement data 3111 will be described. The movement data 3111 includes movement logs (for example, GPS information entry) of human being, and house movement data. The feature value generation unit 3301 can generate the feature value vector of the target property by using the movement logs of the human being or the house movement data. In the following, it will be described specifically.

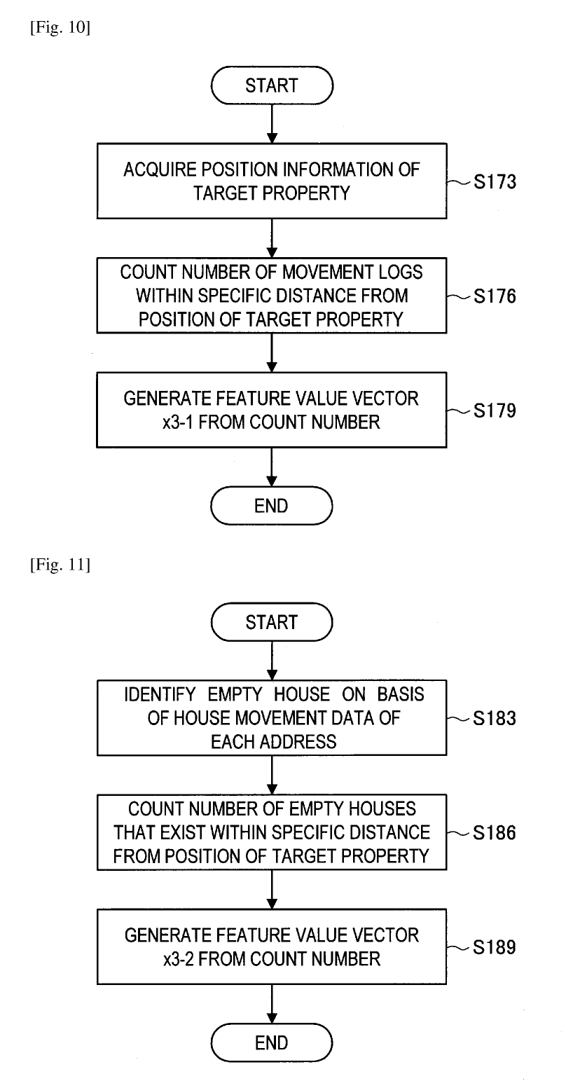

FIG. 10 is a flowchart illustrating the generation process of the feature value vector based on the movement logs according to the present embodiment. As illustrated in FIG. 10, first, in S173, the feature value generation unit 3301 acquires the position information of the target property (for example, position information (latitude and longitude) included in the property feature value, or position information (latitude and longitude) that can be acquired from address information (location information)).

Thereafter, in S176, the feature value generation unit 3301 counts the number of movement logs within a specific distance from the position of the target property. The number of movement logs within specific distance from the position of the target property is the number of persons who have visited the surrounding area of the target property, for example. Also, the count of the number of movement logs may be the sum of the number of movement logs, and may be the amount of change. Also, the feature value generation unit 3301 may count the number (staying number) of staying points of the movement logs within a specific distance from the position of the target property, in order to exclude the number of persons who pass for the purpose of moving to another area. In this case, the feature value generation unit 3301 counts the number of staying points on the basis of the average value of the observation points that are included within a radius of 100 m for 30 minutes or more continuously, for example. Also, it may be such that the staying points that have stayed at 2 a.m. (or within a certain amount of time, such as 2 a.m. to 4 a.m.) for example are not counted with respect to each user ID in order to exclude stay (residency) in home.

Thereafter, in S179, the feature value generation unit 3301 generates the feature value vector x3-1 from the count number.

FIG. 11 is a flowchart illustrating the generation process of the feature value vector based on the house movement data according to the present embodiment. As illustrated in FIG. 11, first, in S183, the feature value generation unit 3301 identifies empty houses on the basis of the house movement data. Specifically, the feature value generation unit 3301 confirms whether or not carrying-in/carrying-out information of the latest year, month, and day of each address is 0, on the basis of the house movement data, and, if 0, identifies the address as an empty house address.

Thereafter, in S186, the feature value generation unit 3301 counts the number of empty houses that exist within a specific distance from the position of the target property.

Thereafter, in S189, the feature value generation unit 3301 generates the feature value vector x3-2 from the count number.

As described above, the feature value generation unit 3301 can generate the feature value vector of the target property, on the basis of the number of empty houses around the target property. Also, the feature value generation unit 3301 can generate the feature value vector of the target property, by adding the feature value vectors based on the property feature information of the empty houses around the target property. Alternatively, the feature value generation unit 3301 may generate the feature value vector of the target property on the basis of the number of empty houses of the properties similar to the target property.

The feature value generation unit 3301 combines the above calculated feature value vector x3-1 and the feature value vector x3-2, in order to generate the feature value vector x3.

Although, in the above, the feature value vector generation process of the property has been described specifically, the present embodiment is not limited thereto, but may generate the feature value vector by utilizing advertisement information of the property (posting medium and scale, post target, period, content of advertisement, etc.), and may generate the feature value vector by utilizing population of the surrounding area of the property, its components, and their change, for example. In the present embodiment, the contract probability can be predicted more accurately, by calculating each of feature value vectors xN by utilizing information other than real estate brokerage (i.e., information other than the sales data and the transaction history data), and using the feature value vector x of the property which is generated by combining these feature value vectors xN.

### 4. Exemplary Information Presentation Screen Image

Next, an example of information presented in an embodiment of the present disclosure will be described, with reference to an example of the screen image displayed on the display included in the input-output unit 140 in the clients 100, for example. Although the following description describes an example of information presented for selling a condominium apartment, the information can be presented in the same way when selling an independent building and land for example, which are not a condominium apartment. Also, the same information can be presented to rent properties (real estates).

In the embodiment, decision of the property sales price by the seller (property owner, that is, the user) of the condominium apartment can be assisted by displaying the predicted value of the contract probability along the number of elapsed days (predetermined period) from sales start.

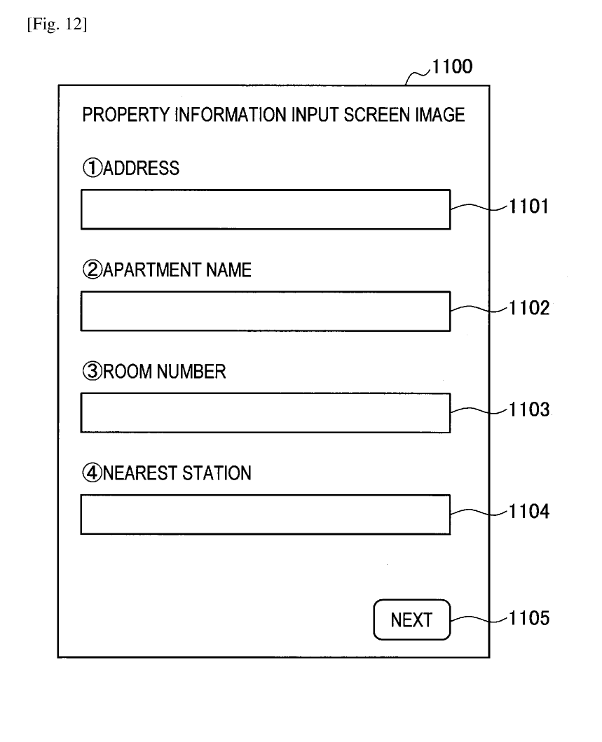

FIG. 12 is a diagram illustrating an example of the property information input screen image displayed in the present embodiment. In the example illustrated in the drawing, input fields of address 1101 (“address” may be displayed as “location”), apartment name 1102, room number 1103, and nearest station 1104 are displayed in the screen image 1100. The user inputs information into these input fields, and when completes, presses a “next” button 1105. Note that, when the apartment name input into the apartment name 1102 is registered in the property data 3101 already, other information such as the address 1101 and the nearest station 1104 may be set automatically, for example. Alternatively, selectable room numbers 1103 and nearest stations 1104 may be displayed in a list, for example.

The property information input from the screen image 1100 is transmitted to the server 300 via the network 200 from the clients 100. The information presenting unit 3309 of the server 300 searches for the corresponding property from the property data 3101, on the basis of the property information received from the clients 100 by the communication unit 320, in order to identify the sales property. When the sales property is identified, the information presenting unit 3309 performs a control to display a consideration screen image of the sales price and the advertisement method on the display included in the input-output unit 140 of the clients 100, in order to register the price and the advertisement method of the sales property as the sales data 3103. In the following, the consideration screen image of the price (sales price) of the sales property and the like will be described by using a plurality of examples.

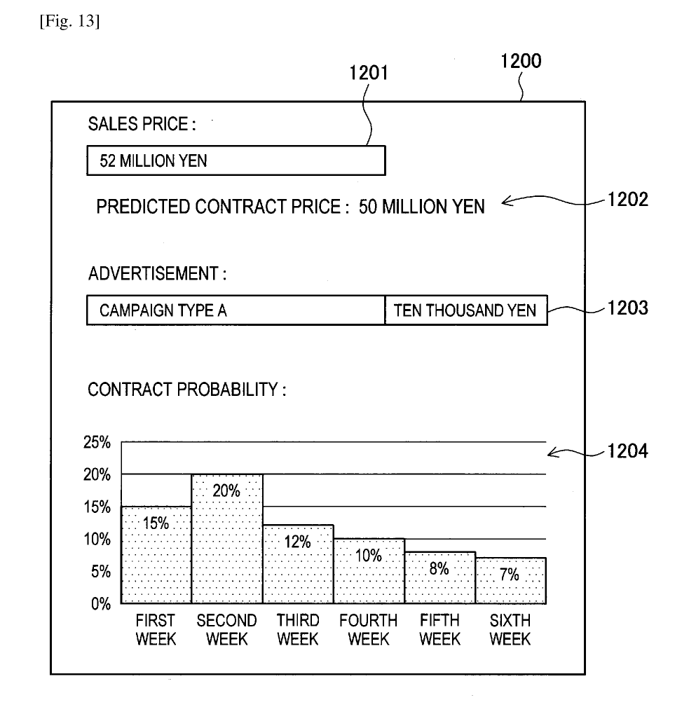

FIG. 13 is a diagram illustrating an example of a sales price consideration screen image displayed in the present embodiment. In the example illustrated in the drawing, a sales price input field 1201, a predicted contract price 1202, an advertisement campaign type 1203, and contract probability information 1204 of respective predetermined transaction period are displayed in the screen image 1200. The predicted contract price 1202 can be calculated by the predicting unit 3306, on the basis of the feature value vector of the target sales property. The feature value vector of the target sales property may be calculated in advance by the feature value generation unit 3301 and stored in the feature value data 3113, and may be calculated again by the feature value generation unit 3301 and stored in the feature value data 3113, when the predicting unit 3306 executes the prediction process. The seller can consider the sales price with reference to the displayed predicted contract price 1202. Although, in the present embodiment, the predicted contract price 1202 is displayed as one of consideration materials of the sales price, this is an example, and the predicted contract price 1202 is needless to be displayed on the consideration screen image. Also, an assessed value may be displayed, if the assessed value of the property is known, instead of the predicted contract price 1202. Also, the screen image configuration of FIG. 13 is an example, and the layout of information is not limited thereto.

Also, when the seller inputs the sales price into the sales price input field 1201, and selects the advertisement campaign type 1203 (for example, advertisement budget), the contract probability information 1204 of each predetermined transaction period is displayed. In the example illustrated in the drawing, the contract probability information 1204, for example the contract probability information 1204 in the first week, the second week, the third week . . . from the sales start day, is displayed in a graph. Specifically, the input sales price and advertisement campaign type are transmitted to the server 300 via the network 200 from the clients 100, and the contract probability information 1204 is calculated by the predicting unit 3306 of the server 300. The predicting unit 3306 acquires the feature value vector x of the target sales property regenerated by the feature value generation unit 3301, including the received sales price and the advertisement campaign type. For example, the feature value generation unit 3301 regenerates the feature value vector x of the target sales property, by combining the feature value vector x of the sales property that is calculated already and stored in the feature value data 3113, with the feature value vector x generated on the basis of the sales price and the advertisement campaign type, and outputs the regenerated feature value vector x to the predicting unit 3306. The predicting unit 3306 calculates the contract probability of the sales property at a time point when a predetermined number of days has passed, by assigning the feature value vector x of the target sales property and the designated number of elapsed days y (the number of elapsed days from the sales start day), to the prediction model (refer to the above formula 2) of the contract probability using various types of parameters extracted from the parameter data 3115. Note that, when the contract probabilities in the first week, the second week, the third week . . . from the sales start day are displayed in a graph as illustrated in FIG. 13, the predicting unit 3306 calculates contract probabilities of respective elapsed days, such as the first day, the second day, the third day . . . from the sales start day, and calculates the contract probability of each week by adding the contract probabilities of respective days of the week, for example.

In the example illustrated in FIG. 13, when the target sales property is set at the sales price of 52 million yen and the advertisement campaign type A, it is known that the probability of making a contract within the first week (7 days from the sales start day) is 15%, and the probability of making a contract within the second week (7 days after 7 days from the sales start day) is 20%, and the probability of making a contract within the third week (7 days after 14 days from the sales start day) is 12%, and the probability of making a contract within the fourth week is 10%, and the probability of making a contract within the fifth week is 8%, and the probability of making a contract within the sixth week is 7%. The seller can consider the sales price and the advertisement campaign selection with reference to this contract probability information 1204.

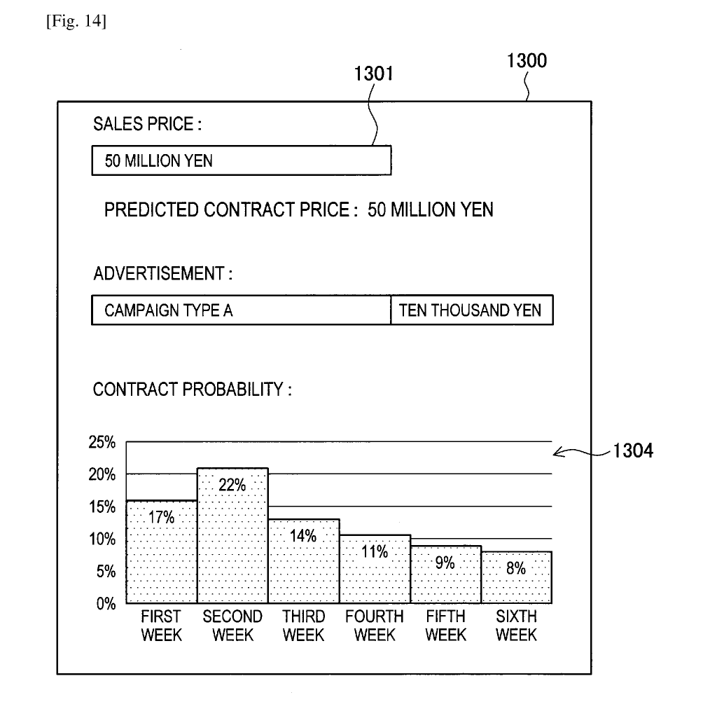

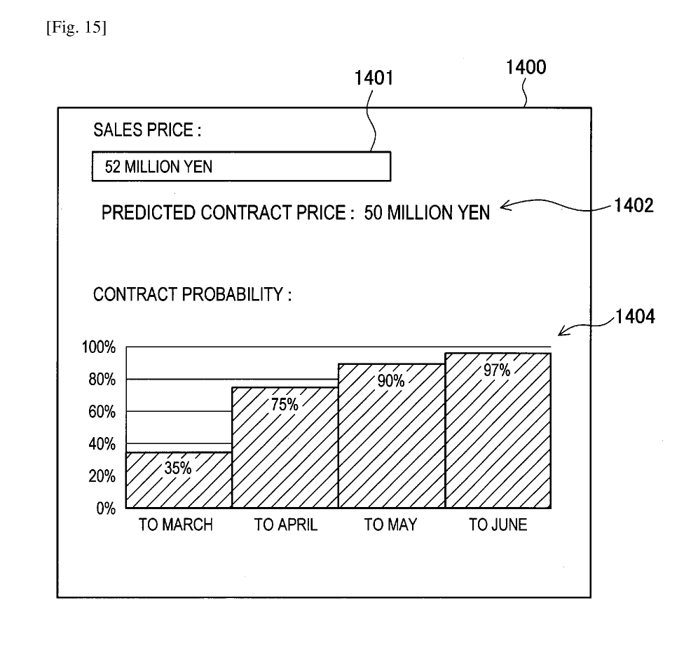

When one of the sales price 1201 and the advertisement campaign type 1203 changes in FIG. 13, the prediction result of the contract probability changes, and thus the contract probabilities within predetermined transaction periods are updated in response to the input detail, and the display of the user interface is updated as illustrated in FIG. 14.

FIG. 14 is a diagram illustrating an example in which the displayed sales price consideration screen image is updated in the present embodiment. The screen image 1300 illustrated in the drawing is the screen image updated because the sales price 1301 changes from 52 million yen (the sales price 1201 of FIG. 13) to 50 million yen. In response to the change of the sales price 1301, the contract probability information 1304 also changes from the contract probability information 1204 illustrated in the screen image 1200 of FIG. 13. Specifically, the sales price is reduced to 50 million yen, and thereby the probability of making a contract within the first week increases to 17%, and the probability of making a contract within the second week increases to 22%, and the probability of making a contract within the third week increases to 14%, and the probability of making a contract within the fourth week increases to 11%, and the probability of making a contract within the fifth week increases to 9%, and the probability of making a contract within the sixth week increases to 8%.

As described above, the seller can consider selecting the sales price and the advertisement campaign, with reference to the contract probability information updated in response to the change of the selection of the sales price and the advertisement campaign.

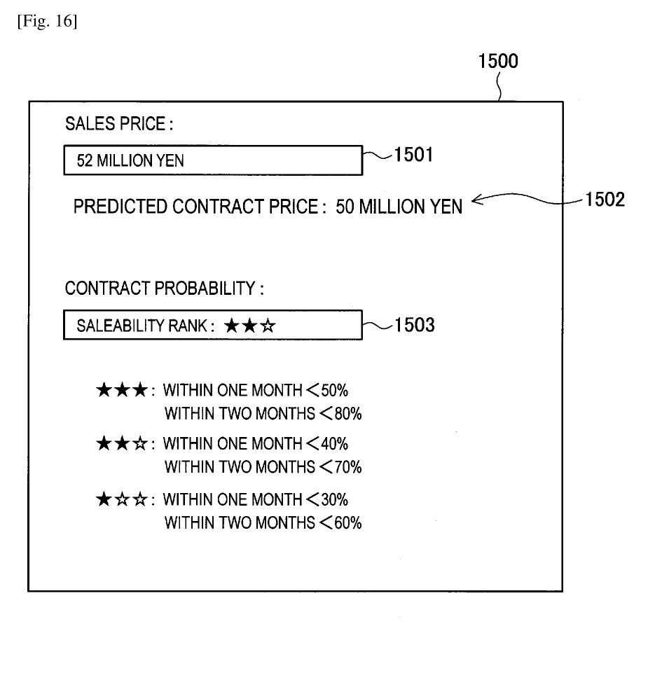

Next, an example of another user interface is illustrated in FIGS. 15 to 22. FIG. 15 is a diagram illustrating an exemplary screen image that displays accumulation of contract probabilities. In the example illustrated in the drawing, a sales price 1401 input by the seller, a predicted contract price 1402 predicted on the basis of the feature value of the sales property, and contract probability information 1404 predicted on the basis of the feature value of the sales property including the sales price are displayed in the screen image 1400. In the contract probability information 1404 illustrated in FIG. 15, the accumulated total of the contract probability from the sales start day to each month is displayed in a graph. Specifically, when the sales start day is March 1 for example, the accumulative contract probability to the end of March is 35%, and the accumulative contract probability from the sales start day to the end of April is 75%, and the accumulative contract probability from the sales start day to the end of May is 90%, and the accumulative contract probability from the sales start day to the end of June is 97%.

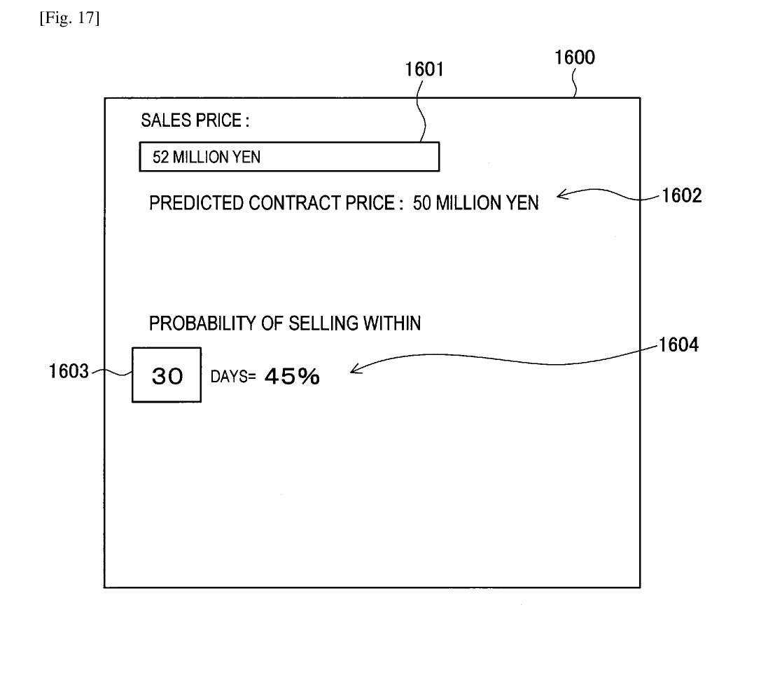

FIG. 16 is a diagram illustrating an exemplary screen image that displays the contract probability with a rank according to saleability. Here, the contract probability is converted not to percentage but to simple expression, in order to present it to the seller in an easily understandable manner. In the example illustrated in the drawing, a sales price 1501, a predicted contract price 1502, and contract probability information 1503 are displayed in the screen image 1500. The contract probability is converted to saleability expression of 3 ranks by the setting of the adequate threshold value, and the saleability rank is represented by the number of stars in the contract probability information 1503. For example, when the contract probability within one month (the accumulative contract probability of one month from the sales start day) is less than 30%, and the contract probability within two months (the accumulative contract probability of two months from the sales start day) is less than 60%, the “saleability rank” is displayed with one star indicating the lowest evaluation of 3 ranks, and when the contract probability within one month is less than 40% and the contract probability within two months is less than 70%, the “saleability rank” is displayed with two stars, and when the contract probability within one month is less than 50% and the contract probability within two months is less than 80%, the “saleability rank” is displayed with three stars indicating the best evaluation.

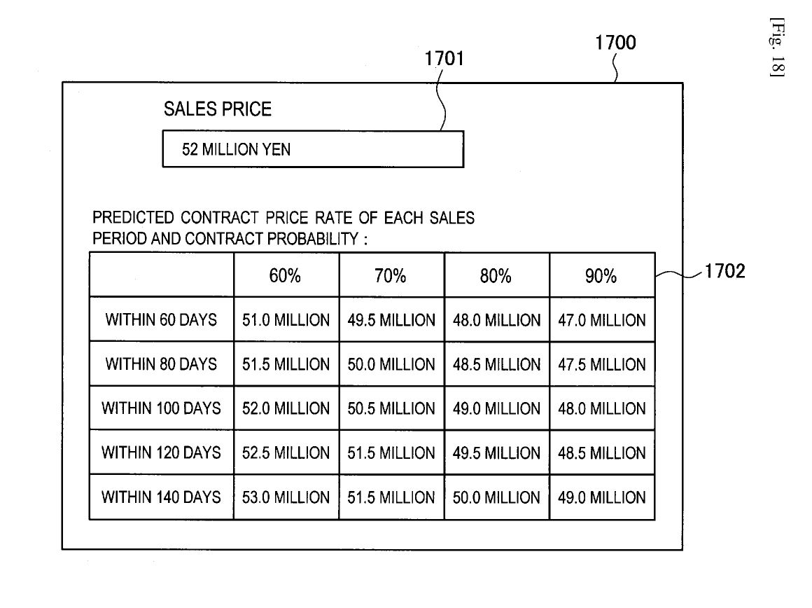

FIG. 17 is a diagram illustrating an exemplary screen image that displays the contract probability within a designated contract period. In the example illustrated in the drawing, a sales price 1601, a predicted contract price 1602, a designated contract period 1603, and contract probability information 1604 are displayed in the screen image 1600. The seller inputs an arbitrary sales price into the sales price 1601 and inputs an arbitrary contract period into the designated contract period 1603 y, so that the contract probability up to the input contract period is predicted and displayed.

FIG. 18 is a diagram illustrating an exemplary screen image that displays a list of predicted contract prices for each contract probability and each sales period. In the example illustrated in the drawing, a sales price 1701 and predicted contract price information 1702 are displayed in the screen image 1700. The predicted contract price information 1702 includes a table indicating the predicted contract prices of each contract probability (for example, 60%, 70%, 80%, 90%) in each sales period (for example, within 60 days, within 80 days, within 100 days, within 120 days, within 140 days), for example. The seller can consider the sales price 1701 with reference to the predicted contract price information 1702.

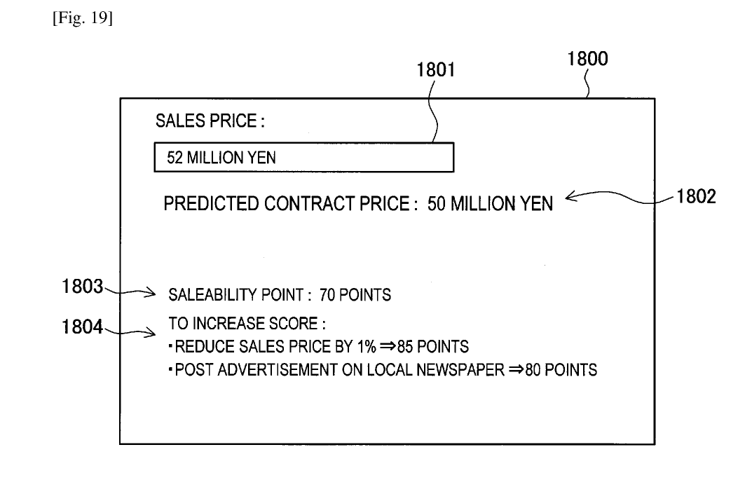

FIG. 19 is a diagram illustrating an exemplary screen image that displays the contract probability with score. In the example illustrated in the drawing, a sales price 1801, a predicted contract price 1802, a saleable point value 1803, and score change information 1804 are displayed in the screen image 1800. The contract probability in a certain period (for example, one month or two months, etc.) is converted to a value of 0 to 100, and displayed as a score in the saleable point value 1803. In conversion to the point value of the contract probability, a threshold value of conversion is set as appropriate in such a manner that the contract probability is higher as closer to 100, for example. The score change information 1804 includes information for increasing the saleable point value. Specifically, the point value as well as the contract probability within a certain period is changed because of the change of the sales price and the addition of the advertisement campaign for example, and thus the information such as “reduce sales price by 1%: 85 points” and “post advertisement on local newspaper: 80 points” is displayed. Note that, in the case of the advertisement campaign, it is envisaged that the contract probability is different depending on the advertisement site and the advertisement target, with even the same advertisement cost, and in that case the one that increases the contract probability most may be selected and presented.

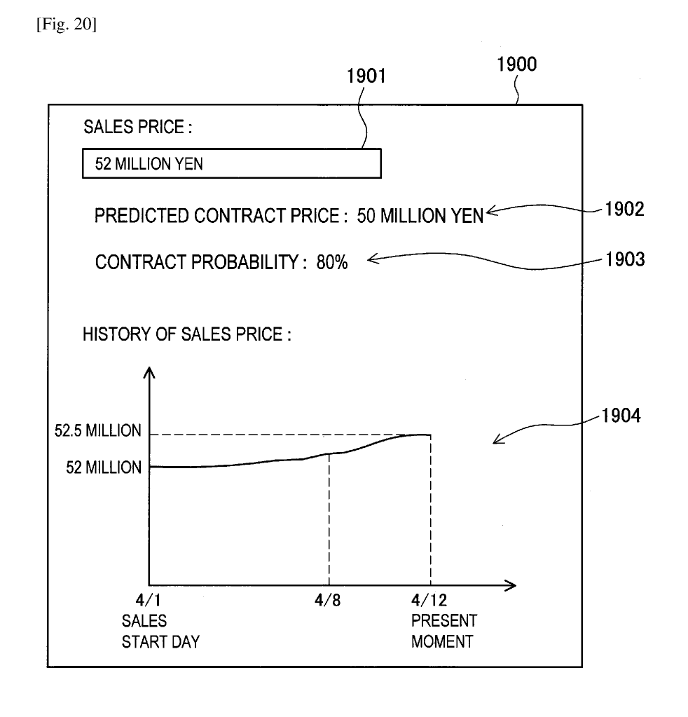

FIG. 20 is a diagram illustrating an exemplary screen image that displays an automatic adjustment history of a sales price. In the example illustrated in the drawing, a sales price 1901, a predicted contract price 1902, a contract probability 1903 within a predetermined contract period, and an automatic adjustment history 1904 of the sales price are displayed in the screen image 1900. The automatic adjustment of the sales price can be performed by the price adjusting unit 3312 of the server 300. In the example illustrated in FIG. 20, the contract probability 1903 within a predetermined contract period is set, and the sales price is adjusted by the price adjusting unit 3312 in such a manner to maintain the set contract probability. The contract probability changes with the elapsed time (for example, as illustrated in FIG. 4, the contract probability rapidly increases during substantially 20 days from the sales start day and thereafter gradually decreases), and thus the price adjusting unit 3312 adjusts the sales price to maintain the set contract probability. The automatic adjustment history 1904 displays the history of the sales price adjusted as described above. In the example illustrated in the drawing, the sales starts from April 1 with the sales price “52 million” input by the seller, and for example April 8 to 12 (present moment) is a saleable period, and thus the sales price is adjusted at a high price (to maintain the contract probability 80%).

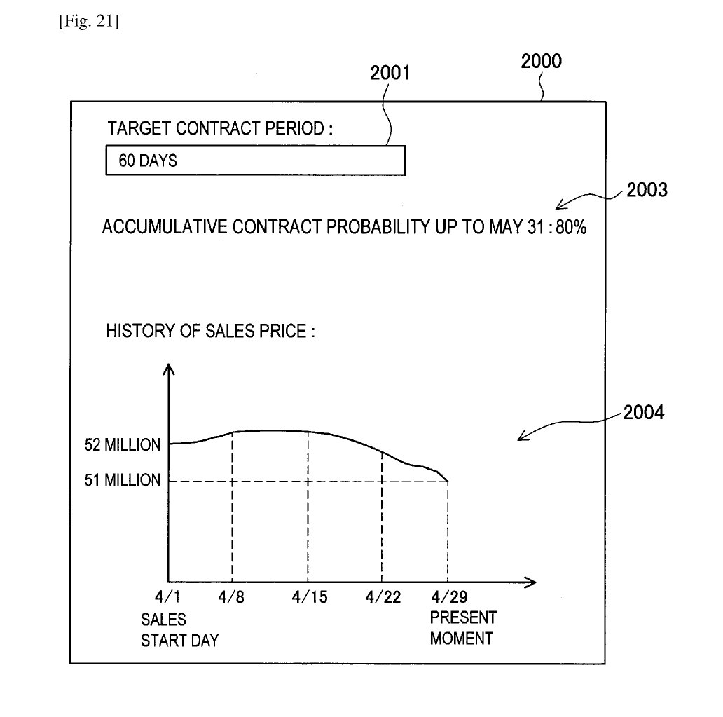

FIG. 21 is a diagram illustrating an exemplary screen image for setting the target contract period in the automatic adjustment of the sales price. In the example illustrated in the drawing, a target contract period 2001, an accumulative contract probability 2003 within a target contract period, and an automatic adjustment history 2004 of the sales price are displayed in the screen image 2000. The price adjusting unit 3312 adjusts and reduces the sales price, when it is close to the target contract period input by the seller. Here, the price adjusting unit 3312 adjusts the sales price in such a manner that the accumulative contract probability within the target contract period is at 80%, for example. Setting of the accumulative contract probability may be performed by the seller optionally, and may be decided by the system side as appropriate. The contract probability from the present moment to the target contract period can be calculated by dividing “contract probability from sales start day” by “1−contract probability from sales start day to present moment”.

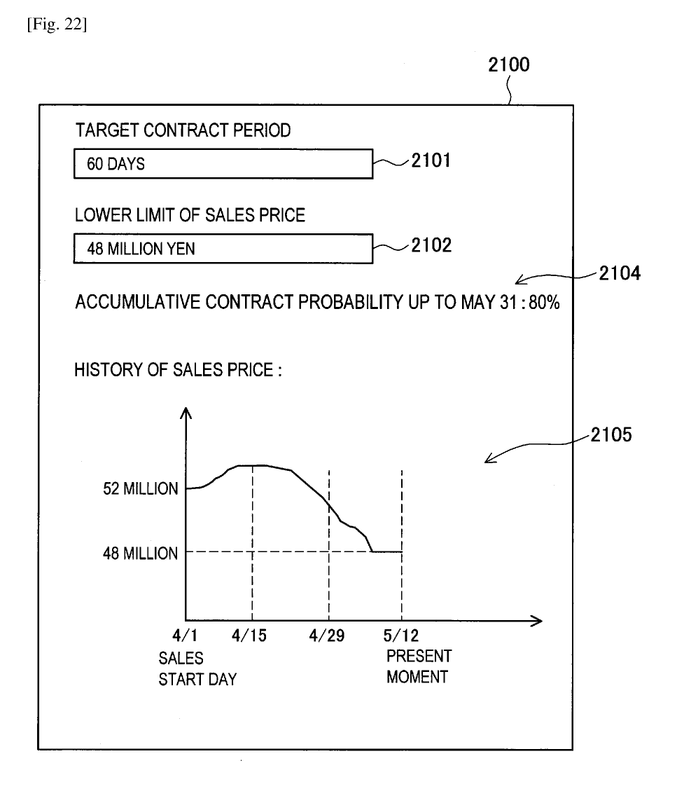

FIG. 22 is a diagram illustrating an exemplary screen image for setting a lower limit in the automatic adjustment of the sales price. In the case where the sales price is adjusted when it is close to the target contract period as described above, it is possible that the sales price becomes too low, and thus the seller may set the lower limit of the sales price in advance as illustrated in the screen image 2100 of FIG. 22. In the example illustrated in the drawing, a target contract period 2101, a lower limit 2102 of the sales price, an accumulative contract probability 2104 within a target contract period, and an automatic adjustment history 2105 of the sales price are displayed in the screen image 2100. The price adjusting unit 3312 adjusts and reduce the sales price when it is close to the target contract period input by the seller, and adjusts the sales price in such a manner that the accumulative contract probability within the target contract period is at 80% for example, and here adjusts the sales price so as not to become lower than the set lower limit (for example, 48 million yen) of the sales price.

### 5. Application Example

Although, in the above, a case has been described in which the contract probability is used when the seller decides the sales price, the present disclosure is not limited thereto, but the contract probability may be used in another use described below.

<5-1. Utilization at Buyer Side>

For example, changes of current contract probability and future contract probability of the sales property are displayed on a web page of the sales property browsed by the user (the buyer) who is considering purchasing the property, so that the buyer can refer to it to make an intention decision of the purchase or to negotiate the contract price. Specifically, for example the buyer can make an intention decision of the purchase at an early stage, as the contract probability is high, and can negotiate aggressively to reduce the price, as the contract probability is low.

Also, the information presenting unit 3309 of the server 300 may issue an alert to the buyer, when the contract probability increases (that is, the demand increases) with increasing accesses to the property page, the number of elapsed days, and the like, with respect to the property the bookmarked (registered to access immediately on a real estate information site) by the buyer who is considering the purchase of the property. The alert to the buyer can be performed by using an e-mail, for example. Moreover, when the prediction of the contract period is also performed by the predicting unit 3306, and the prediction contract period of the property bookmarked by the buyer becomes short, the information presenting unit 3309 may issue an alert to the buyer. Thereby, the buyer can refer to it to make a determination such as buying and selling negotiation, before the bookmarked property is bought by another person.

<5-2. Utilization at Real Estate Broker Side>

Also, the contract probability according to the present embodiment can be referred by a real estate broker, when locating agents for customers (buyers). The real estate broker has a plurality of brokered properties, and therefore the sales efficiency is improved by locating the agents preferentially from the brokered property of the highest contract probability from among them. The contract probability of the brokered property can be presented for each sales property, for each would-be purchaser, or for each would-be purchaser of the target property. As described above, because the buyer information is included in the transaction history data 3105 and used in generation of the feature value by the feature value generation unit 3301, the predicting unit 3306 can predict the contract probability of each would-be purchaser for the target sales property on the basis of a machine learning result by the learning unit 3303 using the feature value.

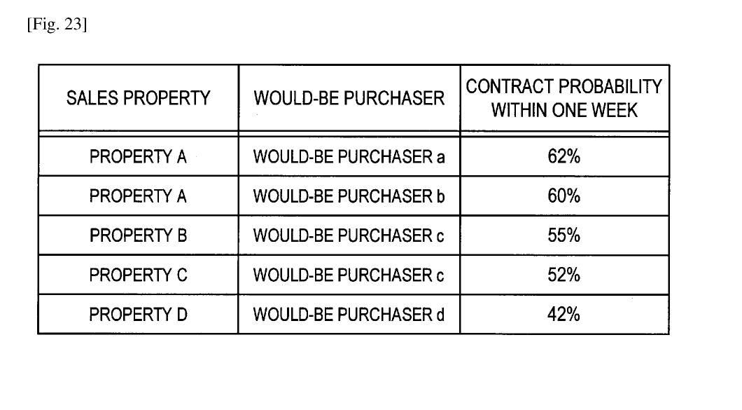

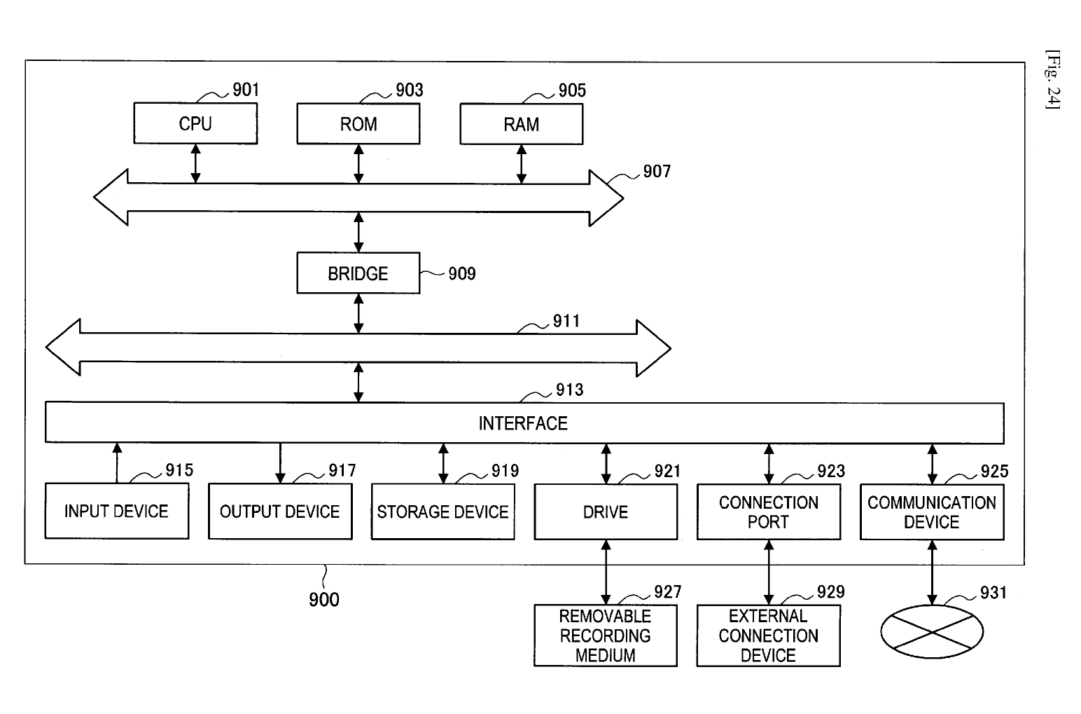

FIG. 23 is a diagram illustrating an exemplary screen image that displays the contract probability of the brokered property. In the example illustrated in the drawing, the contract probability within one week of each would-be purchaser of the sales property is displayed. Specifically, in the display, the contract probability of the would-be purchaser a for the property A is 62%, and the contract probability of the would-be purchaser b for the same property is 60%, and the contract probability of the would-be purchaser c for the property B is 55%, and the contract probability of the would-be purchaser c for the property C is 52%, and the contract probability of the would-be purchaser d for the property D is 42%, for example. Thus, the real estate broker can increase the sales efficiency, by locating the agents for the would-be purchasers of high contract probabilities.

Also, the learning unit 3303 learns the influence to the contract probability of the agent by using the agent information included in the transaction history data 3105 as the feature value, so that the predicting unit 3306 can further predict the contract probability of the brokered property for each agent. For example, a column of agent can be added in the table illustrated in FIG. 23. The information presenting unit 3309 presents the contract probability of the brokered property for each agent, so that the real estate broker can locate each agent appropriately for the customer (the buyer).

<5-3. Application in Real Estate Contract Other Than Buying and Selling>

Although, in the above embodiment, the contract probability is predicted in the buying and selling transaction of the real estate, the present disclosure is not limited thereto, but the predicting unit 3306 can predict the contract probability in rental transaction of the real estate in the same way. Here, the information presenting unit 3309 displays the contract probability in the rental transaction on a UI when a renter decides a rent. Also, the price adjusting unit 3312 can perform the automatic adjustment of the rental price using the contract probability.

Also, the information presenting unit 3309 presents the contract probability in the rental transaction and the contract probability in the buying and selling transaction to the property owner, in order to support the decision of the operation method by the owner (operation by rental, or selling off).

Also, a lodging contract is made for allowing a third person to use the property during the absence of the owner of the real estate property, and at this, the contract probability prediction can be utilized by an embodiment of the present disclosure. The information presenting unit 3309 displays the contract probability in the lodging contract on a UI when the owner of the property decides a lodging charge. Also, the price adjusting unit 3312 can perform the automatic adjustment of the lodging charge using the contract probability. Note that it is not limited to the lodging contract of an individually owned property, but the contract probability prediction can be used when a lodging contract of a general hotel is made. The information presenting unit 3309 displays the contract probability in the lodging contract on a UI when a person responsible of the hotel decides the lodging charge.

<5-4. Utilization in Online Product Sales>

Also, the contract probability according to the present embodiment can be utilized when the sales price of an article is decided in online product sale. The online product sale is a transaction form in which buying and selling of an article is performed on a Web site. An exhibitor of an article sets an explanation and a sales price of the article to release it on the Web site. Here, the contract probability of the article is presented on the UI, so that the exhibitor can set the sales price while referring to the contract probability. Further, the automatic adjustment of the sales price by the price adjusting unit 3312 can also be utilized.

Note that, the domain is different from the real estate, and thus the data that utilizes when the feature value generation is different partially. For example, the feature value generation unit 3301 generates the feature value, by using the site access data and the transaction history data (including the contract information) in the same way as the case of the real estate, and using article data (article name, product number, manufacturer, size, color, sales start year, month, and day, exterior appearance image, etc.) instead of the property data 3101, and without using the movement data 3111.

### 6. Hardware Configuration

Next, with reference to FIG. 24, a hardware configuration of an information processing device according to an embodiment of the present disclosure will be described. FIG. 24 is a block diagram which shows a hardware configuration example of an information processing device according to an embodiment of the present disclosure. The illustrated information processing device 900 may implement, for example, the server 300 and the client 100 in the above embodiments.

The information processing device 900 includes a central processing unit (CPU) 901, a read-only memory (ROM) 903, and a random access memory (RAM) 905. Also, the information processing device 900 may include a host bus 907, a bridge 909, an external bus 911, an interface 913, an input device 915, an output device 917, a storage device 919, a drive 921, a connection port 923, and a communication device 925. The information processing device 900 may include a processing circuit called a digital signal processor (DSP), an application specific integrated circuit (ASIC) or Field-Programmable Gate Array (FPGA) instead of or in addition to the CPU 901.

The CPU 901 functions as an arithmetic processing device and a control device and controls all or some of the operations in the information processing device 900 according to various programs recorded in the ROM 903, the RAM 905, the storage device 919, or a removable recording medium 927. The ROM 903 stores a program, an arithmetic parameter, and the like used by the CPU 901. The RAM 905 primarily stores a program used in execution of the CPU 901 and a parameter or the like appropriately changed in execution of the program. The CPU 901, the ROM 903, and the RAM 905 are connected to each other by the host bus 907 including an internal bus such as a CPU bus. Further, the host bus 907 is connected to the external bus 911 such as a Peripheral Component Interconnect/interface (PCI) bus via the bridge 909.

The input device 915 is, for example, an operation unit manipulated by a user, such as a mouse, a keyboard, a touch panel, a button, a switch, and a lever. Also, the input device 915 may be, for example, a remote control device using an infrared ray or other radio waves or may be, for example, an external connection device 929 such as a mobile phone corresponding to a manipulation of the information processing device 900. Also, the input device 915 includes, for example, an input control circuit that generates an input signal based on information input by a user and outputs the signal to the CPU 901. The user inputs various kinds of data to the information processing device 900 or instructs the information processing device 900 to perform a processing operation by manipulating the input device 915.

The output device 917 includes a device capable of notifying a user of the acquired information visually, audibly or with a tactile sense. Examples of the output device 917 include display devices such as a liquid crystal display (LCD) or an organic electroluminescence (EL) display, audio output devices such as a speaker and a headphone, and a vibrator. The output device 917 outputs a result obtained through the process of the information processing device 900 as a picture such as text or an image, as an audio such as a voice or an acoustic sound, or as vibration.

The storage device 919 is a data storage device configured as an example of the storage unit of the information processing device 900. The storage device 919 includes, for example, a magnetic storage device such as a hard disk device (HDD), a semiconductor storage device, an optical storage device, or a magneto-optical storage device. The storage device 919 stores a program or various kinds of data executed by the CPU 901 and various kinds of data acquired from the outside.

The drive 921 is a reader/writer for the removable recording medium 927 such as a magnetic disk, an optical disc, a magneto-optical disc, or a semiconductor memory, and is built in the information processing device 900 or is attached on the outside thereof. The drive 921 reads information recorded on the mounted removable recording medium 927 and outputs the information to the RAM 905. Also, the drive 921 writes a record on the mounted removable recording medium 927.

The connection port 923 is a port configured to connect a device to the information processing device 900. Examples of the connection port 923 include a Universal Serial Bus (USB) port, an IEEE1394 port, and a Small Computer System Interface (SCSI) port. Other examples of the connection port 923 include an RS-232C port, an optical audio terminal, and a High-Definition Multimedia Interface (HDMI) (registered trademark) port. When the external connection device 929 is connected to the connection port 923, various kinds of data can be exchanged between the information processing device 900 and the external connection device 929.

The communication device 925 is, for example, a communication interface including a communication device connected to a communication network 931. Examples of the communication device 925 include communication cards for a Local Area Network (LAN), Bluetooth (registered trademark), Wi-Fi, and a Wireless USB (WUSB). Also, the communication device 925 may be a router for optical communication, a router for an Asymmetric Digital Subscriber Line (ADSL), or modems for various kinds of communication. For example, the communication device 925 transmits and receives a signal or the like to and from the Internet or another communication device in conformity with a predetermined protocol such as TCP/IP. Also, the communication network 931 connected to the communication device 925 includes networks connected in a wired or wireless manner and includes, for example, the Internet, a household LAN, infrared ray communication, radio-wave communication, or satellite communication.

The example of the hardware configuration of the information processing device 900 has been described above. Each of the foregoing constituent elements may be configured using a general-purpose member or may be configured by hardware specialized for the function of each constituent element. The configuration can be modified appropriately according to a technical level at the time of realizing the embodiments.

### 7. Summary

The embodiments of the present technology can include, for example, the above-described information processing device (a server or a client), a system, an information processing device, an information processing method performed by the information processing device or the system, a program causing the information processing device to function, and a non-transitory type medium having the program stored therein.

It should be understood by those skilled in the art that various modifications, combinations, sub-combinations and alterations may occur depending on design requirements and other factors insofar as they are within the scope of the appended claims or the equivalents thereof.

In addition, the effects described in the present specification are merely illustrative and demonstrative, and not limitative. In other words, the technology according to an embodiment of the present disclosure can exhibit other effects that are evident to those skilled in the art along with or instead of the effects based on the present specification.

Additionally, the present technology may also be configured as below.

(1) A system including:

circuitry configured to

generate a first parameter corresponding to a type of an object;

generate a second parameter corresponding to transaction information corresponding to the object;

calculate a feature value corresponding to the object by applying a predetermined function to the first and second parameters;

generate display data based on the calculated feature value; and

output the display data to a device remotely connected to the system via a network.

(2) The system of (1), wherein

the type of the object corresponds to at least one of land, independent building, apartment, townhouse or commercial property.

(3) The system of any of (1) to (2), wherein

the transaction information includes at least one of a property identifier, sales date, sales price, sales reason, current owner information, demographic information or agent.

(4) The system of any of (1) to (2), wherein

the transaction information corresponds to access information of a website related to the object.

(5) The system of any of (1) to (2), wherein

the transaction information corresponds to movement information of a person related to the object.

(6) The system of any of (1) to (2), wherein

the transaction information relates to advertising data related to a sale of the object.

(7) The system of any of (1) to (6), wherein

the object is a real estate object, and

the circuitry is configured to generate the feature value based on surrounding environment data corresponding to the real estate object.

(8) The system of any of (1) to (7), wherein

the feature value corresponds to a contract probability related to sale of the object over a plurality of transaction periods.

(9) The system of (8), wherein

the generated display data includes data to display the contract probability during each of the plurality of transaction periods.

(10) The system of any of (8) to (9), wherein

the generated display data includes data to display a contract probability over a number of days elapsed since a sales start date.

(11) The system of any of (8) to (10), wherein

the generated display data includes data to display a rank according to saleability of the object.

(12) The system of any of (1) to (11), wherein

the circuitry is configured to generate as user interface configured to receive an input setting a sales price corresponding to the object.

(13) The system of any of (1) to (12), wherein

the predetermined function is a linear regression function.

(14) A system including:

circuitry configured to

generate a feature value corresponding to an object based on a type of the object and transaction information corresponding to the object;

calculate a contract probability related to sale of the object over a predetermined transaction period based on the feature value corresponding to the object; and

output display data indicating the contract probability during the predetermined transaction period.

(15) The system of (14), wherein

the circuitry is configured to calculate the contract probability based on a feature value corresponding to a past transaction object and the feature value corresponding to the object.

(16) The system of (15), wherein

the feature value corresponding to the past transaction object is substantially similar to the feature value corresponding to the object.

(17) The system of any of (14) to (16), wherein

the circuitry is configured to modify a sales price of the object based on the calculated contract probability related to sale of the object over a predetermined transaction period.

(18) The system of (17), wherein the circuitry is configured to:

update the contract probability in response to the modified sales price; and

output display data indicating the updated contract probability during the predetermined transaction period.

(19) A method including:

generating a feature value corresponding to an object based on a type of the object and transaction information corresponding to the object;

calculating a contract probability related to sale of the object over a predetermined transaction period based on the feature value; and outputting display data indicating the contract probability during the predetermined transaction period.

(20) One or more non-transitory computer-readable media including computer program instructions, which when executed by a system, cause the system to:

generate a feature value corresponding to an object based on a type of the object and transaction information corresponding to the object;

calculate a contract probability related to sale of the object over a predetermined transaction period based on the feature value; and

output display data indicating the contract probability during the predetermined transaction period.

(21) An information processing apparatus including:

a calculating unit configured to calculate a feature value of a real estate property or an event relevant to the real estate property; and

a predicting unit configured to predict a contract probability of a predetermined transaction period in a transaction, on the basis of a settlement period and the feature value of a target real estate property in a past settled transaction, and the feature value of the target real estate property of a current transaction.

(22) The information processing apparatus according to (21), wherein

the predicting unit predicts the contract probability within the predetermined transaction period, by using a parameter for calculating a contract probability corresponding to a contract period according to a feature value, which is generated from the settlement period and the feature value of the target real estate property of the past settled transaction having a feature value that is same as the feature value of the target real estate property of the current transaction.

(23) The information processing apparatus according to (21) or (22), wherein

the predicting unit predicts respective contract probabilities of a plurality of transaction periods.

(24) The information processing apparatus according to any one of (21) to (23), further including:

a presentation control unit configured to execute a control to present the contract probability of the predetermined transaction period which is predicted by the predicting unit, to a transactor who performs the current transaction.

(25) The information processing apparatus according to (24), wherein

the presentation control unit executes a control to present the contract probability of the predetermined transaction period, in a transaction price setting screen image for the current transaction.

(26) The information processing apparatus according to (25), wherein

the presentation control unit executes a control to present the contract probability of the transaction period designated by the transactor who performs the current transaction.

(27) The information processing apparatus according to any one of (21) to (26), wherein

the feature value of the event relevant to the real estate property includes a feature value of at least one of the number of accesses and a change of the number of accesses to a web page on which a real estate property of a calculation target or a similar real estate property is posted.

(28) The information processing apparatus according to any one of (21) to (27), wherein

the feature value of the event relevant to the real estate property includes a feature value of at least one of a degree of association or a change of the degree of association between a search history in a web site of real estate information and a real estate property of a calculation target.

(29) The information processing apparatus according to any one of (21) to (28), wherein

the feature value of the event relevant to the real estate property includes a feature value of at least one of a traffic amount or a change of the traffic amount of people around a real estate property of a calculation target.

(30) The information processing apparatus according to any one of (21) to (29), wherein

the feature value of the event relevant to the real estate property includes a feature value of advertisement information of a real estate property of a calculation target.

(31) The information processing apparatus according to any one of (21) to (30), wherein

the feature value of the event relevant to the real estate property includes a feature value of at least one of information of an empty property around a real estate property of a calculation target and around a similar real estate property.

(32) The information processing apparatus according to any one of (21) to (31), further including:

a price adjusting unit configured to adjust a transaction price in the current transaction, according to the predicted contract probability.

(33) The information processing apparatus according to (32), wherein

the price adjusting unit adjusts the transaction price in such a manner that the contract probability is constant, in response to an update of the contract probability.

(34) The information processing apparatus according to (32), wherein

the price adjusting unit adjusts the transaction price in such a manner that the contract probability is constant within a set target settlement period.

(35) The information processing apparatus according to any one of (21) to (34), wherein

the calculating unit periodically updates the feature value.

(36) The information processing apparatus according to (22), further including:

a generation unit configured to generate a parameter that is used in a prediction model for calculating a contract probability corresponding to a contract period, on the basis of the settlement period and the feature value of the target real estate property of the past settled transaction.

(37) The information processing apparatus according to (22), wherein

the predicting unit assigns the feature value of the target real estate property of the current transaction to a function for calculating a contract probability corresponding to a contract period according to a feature value, which is generated from the settlement period and the feature value of the target real estate property of the past settled transaction, to predict the contract probability within the predetermined transaction period.

(38) The information processing apparatus according to (37), wherein

the predicting unit uses a lognormal distribution, as a noise distribution of the contract probability included in the function.

(39) An information processing method including:

calculating, by a processor, a feature value of a real estate property or an event relevant to the real estate property; and

predicting, by the processor, a contract probability of a predetermined transaction period in a transaction, on the basis of a settlement period and the feature value of a target real estate property in a past settled transaction, and the feature value of the target real estate property of a current transaction.

(40) A program for causing a computer to function as:

a calculating unit configured to calculate a feature value of a real estate property or an event relevant to the real estate property; and

a predicting unit configured to predict a contract probability of a predetermined transaction period in a transaction, on the basis of a settlement period and the feature value of a target real estate property in a past settled transaction, and the feature value of the target real estate property of a current transaction.

### REFERENCE SIGNS LIST

10 system
100 client
200 network
300 server
310 database
3101 property data
3103 sales data
3105 transaction history data
3107 surrounding environment data
3109 site access data
3111 movement data
3113 property feature value data
3115 parameter data
320 communication unit
330 processing unit
3301 feature value generation unit
3303 learning unit
3306 predicting unit
3309 information presenting unit
3312 price adjusting unit

1. A system comprising:
circuitry configured to
generate a first parameter corresponding to a type of an object;
generate a second parameter corresponding to transaction information corresponding to the object;
calculate a feature value corresponding to the object by applying a predetermined function to the first and second parameters;
generate display data based on the calculated feature value; and
output the display data to a device remotely connected to the system via a network.

2. The system of claim 1, wherein
the type of the object corresponds to at least one of land, independent building, apartment, townhouse or commercial property.

3. The system of claim 1, wherein
the transaction information includes at least one of a property identifier, sales date, sales price, sales reason, current owner information, demographic information or agent.

4. The system of claim 1, wherein
the transaction information corresponds to access information of a website related to the object.

5. The system of claim 1, wherein
the transaction information corresponds to movement information of a person related to the object.

6. The system of claim 1, wherein
the transaction information relates to advertising data related to a sale of the object.

7. The system of claim 2, wherein
the object is a real estate object, and
the circuitry is configured to generate the feature value based on surrounding environment data corresponding to the real estate object.

8. The system of claim 1, wherein
the feature value corresponds to a contract probability related to sale of the object over a plurality of transaction periods.

9. The system of claim 8, wherein
the generated display data includes data to display the contract probability during each of the plurality of transaction periods.

10. The system of claim 8, wherein
the generated display data includes data to display a contract probability over a number of days elapsed since a sales start date.

11. The system of claim 8, wherein
the generated display data includes data to display a rank according to saleability of the object.

12. The system of claim 1, wherein
the circuitry is configured to generate as user interface configured to receive an input setting a sales price corresponding to the object.

13. The system of claim 1, wherein
the predetermined function is a linear regression function.

14. A system comprising:
circuitry configured to
generate a feature value corresponding to an object based on a type of the object and transaction information corresponding to the object;
calculate a contract probability related to sale of the object over a predetermined transaction period based on the feature value corresponding to the object; and
output display data indicating the contract probability during the predetermined transaction period.

15. The system of claim 14, wherein
the circuitry is configured to calculate the contract probability based on a feature value corresponding to a past transaction object and the feature value corresponding to the object.

16. The system of claim 15, wherein
the feature value corresponding to the past transaction object is substantially similar to the feature value corresponding to the object.

17. The system of claim 14, wherein
the circuitry is configured to modify a sales price of the object based on the calculated contract probability related to sale of the object over a predetermined transaction period.

18. The system of claim 17, wherein the circuitry is configured to:
update the contract probability in response to the modified sales price; and
output display data indicating the updated contract probability during the predetermined transaction period.

19. A method comprising:
generating a feature value corresponding to an object based on a type of the object and transaction information corresponding to the object;
calculating a contract probability related to sale of the object over a predetermined transaction period based on the feature value; and
outputting display data indicating the contract probability during the predetermined transaction period.

20. One or more non-transitory computer-readable media comprising computer program instructions, which when executed by a system, cause the system to:
generate a feature value corresponding to an object based on a type of the object and transaction information corresponding to the object;
calculate a contract probability related to sale of the object over a predetermined transaction period based on the feature value; and
output display data indicating the contract probability during the predetermined transaction period.
